(19) United States
(12) Patent Application Publication
(10) Pub. No.: US 2024/0121686 A1
(43) Pub. Date: Apr. 11, 2024

(54) HANDOVER TECHNIQUE FOR TIME-SENSITIVE NETWORKING

(71) Applicant: Telefonaktiebolaget LM Ericsson (pub)), Stockholm (SE)

(72) Inventors: John Walter DIACHINA, GARNER, NC (US); Marilet DE ANDRADE JARDIM, KISTA (SE); Claes-Göran PERSSON, MJÖLBY (SE)

(73) Assignee: Telefonaktiebolaget LM Ericsson (pub), Stockholm (SE)

(21) Appl. No.: 18/275,757

(22) PCT Filed: Feb. 4, 2022
(86) PCT No.: PCT/EP2022/052768

§ 371 Date: Aug. 3, 2023

Related U.S. Application Data
(60) Provisional application No. 63/146,466, filed on Feb. 5, 2021.

(51) Int. Cl. H04W 36/26; H04W 36/08; H04W 36/18

(52) U.S. Cl. CPC H04W 36/26; H04W 36/08; H04W 36/185

(57) ABSTRACT

A technique for forwarding data packets (730) during a handover of a radio device (100) from a source cell to a target cell of a radio network (702) serving as a time-sensitive networking, TSN, bridge (700) is described. As to a method aspect of the technique at the radio device (100), first TSN data packets (730) are forwarded in the source cell using a first PDU session (704) between the radio device (100) and a user plane, UP (300), of a core network, CN (720), of the radio network (702). Prior to releasing the first PDU session (704), a second PDU session (704) is established (404) between the radio device (100) and the UP (300) of the CN (720) in the target cell, wherein the first PDU session (704) uses a first active protocol stack at the radio device (100) and the second PDU session (704) uses a second active protocol stack at the radio device (100). Second TSN data packets (730) are forwarded in the target cell using the second PDU session (704).

### TECHNICAL FIELD

The present disclosure relates to a technique for forwarding time-sensitive networking, TSN, data packets during a handover. More specifically, and without limitation, methods and devices are provided for forwarding data packets at a radio device and a user plane of a core network, respectively, during a handover of the radio device from a source cell to a target cell of a radio network serving as a TSN bridge.

### BACKGROUND

Release 16 of the Third Generation Partnership Project (3GPP) specifies time-sensitive communication (TSC) for Fifth Generation (5G) systems (5GS) based on an integration with a set of IEEE standards for time-sensitive networking (TSN) developed by the IEEE 802.1 TSN task group. TSC is a communication service that supports deterministic communication and isochronous communication with high reliability and availability. This is achieved by hard guarantees for QoS characteristics such as latency bounds, packet loss and reliability, and synchronization, e.g., down to the nanosecond level.

Release 17 of 3GPP enhances the 5G systems to support inter-working with TSC involving both time-sensitive networking (TSN) and non-TSN services, which can address the key concept of using 5G-based wireless operation in the context of factory automation, e.g. a 5GS working as a bridge to support inter-working with Ethernet-based or IP based industrial communication networks.

In a conventional inter-node handover due to mobility of a radio device such as a 3GPP user equipment (UE), the radio device releases a connection to a source cell before the link to the target cell is established, i.e., uplink and downlink transmission is stopped in the source cell before the radio device starts to communicate with the target cell, which causes an interruption in the transmission of user data in the UL and DL in the range of a few tens of milliseconds. Such an interruption is incompatible with TSN.

As a means to minimize the interruption, 3GPP Release 16 defined a Dual Active Protocol Stack (DAPS) for a handover, e.g., according to the 3GPP document TS 38.300, version 16.4.0. The DAPS enables the radio device to maintain the connection with the source access node after reception of a control message including a handover command until releasing the source cell when random access to the target gNB has been successfully completed.

However, the conventional DAPS handover requires the source access node to forward copies of the DL data to the target access node for transmitting the DL data indirectly to the radio device, which can introduce a delay that is incompatible with TSN, e.g., because the delay is longer than a TSN delay budget or because the delay is not deterministic for the TSN bridge.

### SUMMARY

Accordingly, there is a need for a handover technique that is compatible with time-sensitive networking.

As to a first method aspect a method of forwarding data packets at a radio device during a handover of the radio device from a source cell to a target cell of a radio network serving as a time-sensitive networking (TSN) bridge is provided. The method comprises or initiates the step of forwarding first TSN data packets in the source cell using a first PDU session between the radio device and a user plane (UP), of a core network (CN), of the radio network. The method further comprises or initiates the step of prior to releasing the first PDU session, establishing a second PDU session between the radio device and the UP of the CN in the target cell. The first PDU session uses a first active protocol stack at the radio device and the second PDU session uses a second active protocol stack at the radio device. The method further comprises or initiates the step of forwarding second TSN data packets in the target cell using the second PDU session.

By establishing the second PDU session prior to releasing the first PDU session, the radio device is enabled to switch (e.g., after the establishing of the second PDU session and/or before releasing the first PDU session) from using the first PDU session to using the second PDU session at a point in time that is determined by or consistent with the TSN bridge, e.g., an operation of the TSN bridge. For example, the point in time may be determined by and/or may be consistent with a gate open time interval for the TSN bridge and/or a TSC assistance information (TSCAI) for the TSN bridge.

Herein, the source cell and the target cell may relate to different (e.g., non-overlapping) radio resources, e.g. scheduled (also referred to as managed or controlled) by one or more access nodes of the source cell and the target cell, respectively. The different radio resources of the source cell and the target cell may be scheduled by the same access node, i.e., the source access node may be the target access node serving both the source and the target cell. Alternatively or in addition, the source access node (also referred to as a first access node) and the target access node (also referred to as a second access node) may be different (e.g., spaced apart) from the source access node.

The radio resources may comprise temporal resources (e.g., one or more of symbols, transmission time intervals, subframes, and radio frames), frequency resources (e.g., one or more of subcarriers, physical resource blocks, bandwidth parts, and carriers).

The (e.g., second) PDU session may be established using non-assess stratum (NAS) signaling (e.g., between the radio device and the CN).

The first PDU session may uses at least one data radio bearer (DRB) between the radio device and the source access node. The second PDU session may uses at least one DRB between the radio device and the target access node.

The radio device may be a mobile terminal or a baseband unit of a device for machine-type communication (MTC), e.g., devices of a manufacturing plant.

The first active protocol stack may be a user plane (UP) protocol stack at the radio device for radio communication (i.e., access stratum) in the source cell and/or with the source access node. The second active protocol stack may be a UP protocol stack at the radio device for radio communication (i.e., access stratum) in the target cell and/or with the target access node.

The radio device (e.g., according to the first method aspect) may switch from using the first PDU session to using the second PDU at a point in time that is determined by or consistent with the radio network serving as the TSN bridge and/or the point in time is determined by and/or consistent with a gate open time interval for the TSN bridge and/or a TSN assistance information (TSCAI) for the TSN bridge and/or a forwarding configuration of the TSN bridge.

The forwarding (e.g., according to the first method aspect) of the first TSN data packets may comprise an uplink transmission of the first TSN data packets to the UP of the CN using the first PDU session. Alternatively or in addition, the forwarding (e.g., according to the first method aspect) of the second TSN data packets may comprise an uplink transmission of the second TSN data packets to the UP of the CN using the second PDU session. Switching from the transmission (e.g., according to the first method aspect) using the first PDU session to the transmission using the second PDU session may be synchronized with at least one of the serving as the TSN bridge, the gate open time interval for the TSN bridge, and the TSCAI for the TSN bridge.

The radio device (e.g., according to the first method aspect) may be allocated a downlink radio resource for a first QoS flow in the first PDU session and an uplink radio resource for a second QoS flow in the first PDU session.

Both the first QoS flow and the second QoS flow may be supported within the first PDU session (briefly referred to as first QoS flows of or in the first PDU session). The DL radio resource of the first QoS flow and/or the UL radio resource of the second QoS flow may be allocated by the (e.g., source) access node of the source cell. The DL radio resource of the first QoS flow may be allocated using semi-persistent scheduling (SPS). The UL radio resource of the second QoS flow may be allocated using a configured grant (CG).

The radio device (e.g., according to the first method aspect) may be allocated a downlink radio resource for a third QoS flow in the second PDU session and an uplink radio resource for a fourth QoS flow in the second PDU session.

Both the third QoS flow and the fourth QoS flow may be supported within the second PDU session. The DL radio resource of the third QoS flow and/or the UL radio resource of the fourth QoS flow may be allocated by the (e.g., target) access node of the target cell. The DL radio resource of the third QoS flow may be allocated using SPS. The UL radio resource of the fourth QoS flow may be allocated using a CG.

The second PDU session (e.g., according to the first method aspect) may be established responsive to receiving a control message in the source cell, optionally a radio resource control (RRC) message.

Establishing a PDU session may also be referred to as PDU session establishment.

The control message (e.g., according to the first method aspect) may be indicative of at least one of the handover, the serving as a TSN bridge, a reduction of an interruption time during the handover, and separately using a first active protocol stack for the source cell and a second active protocol stack for the target cell.

The interruption time during the handover may be reduced without using a dual active protocol stack (DAPS) and/or without forwarding TSN data packets from the source access node to the target access node.

The radio device may comprise a device-side TSN translator (DS-TT) providing at least one of an egress port and an ingress port of the TSN bridge at the device side. Alternatively or in addition, the UP of the CN may comprise a network-side TSN translator (NW-TT) providing at least one of an ingress port and an egress port of the TSN bridge at the network side.

The first TSN data packets (e.g., according to the first method aspect) in the first PDU session and the second TSN data packets in the second PDU session may be forwarded from a device-side TSN translator (DS-TT) at the radio device for uplink transmission to the UP of the CN. Alternatively or in addition, the first TSN data packets in the first PDU session and the second TSN data packets in the second PDU session are forwarded to the DS-TT at the radio device after downlink reception from the UP of the CN.

The DS-TT may be implemented as a layer above both the first active protocol stack and the second active protocol stack at the radio device and/or as an application layer of the protocol stack at the radio device.

The forwarding (e.g., according to the first method aspect) of the first TSN data packets in the first PDU session and/or the second TSN data packets in the second PDU session may comprise temporarily gating the respective TSN data packets according to the gate open time interval for the TSN bridge and/or the TSCAI for the TSN bridge and/or the forwarding configuration of the TSN bridge.

The same gate open time interval for the TSN bridge (e.g., according to the first method aspect) and/or the same TSCAI for the TSN bridge and/or the same forwarding configuration of the TSN bridge may be applied to both the first TSN data packets in the first PDU session and the second TSN data packets in the second PDU session.

The forwarding (e.g., according to the first method aspect) of the first TSN data packets may comprise transmitting the first TSN data packets in the first PDU session until the switching to the second PDU session at a point in time after completion of the second PDU session in the target cell.

The switching may be delayed after the completion for TSN synchronization. The completion of the second PDU session in the target cell may comprise a completion of a random access procedure in the target cell.

The radio device (e.g., according to the first method aspect) may be configured to continue at least one of downlink reception and uplink transmission of the first TSN data packets in the source cell using the first PDU session while establishing the second PDU session in the target cell.

Establishing the second PDU session in the target cell may comprise completing a (e.g., radio) connection to the target cell. Completion of establishing the PDU session in the target cell may comprise completion of a random access procedure in the target cell.

The first active protocol stack (e.g., according to the first method aspect) and the second active protocol stack may be simultaneously active at the radio device during the handover.

Each of the first active protocol stack and the second active protocol stack at the radio device (e.g., according to the first method aspect) may comprise a user plane (UP) protocol stack and/or an access stratum (AS) protocol stack for the source cell and the target cell, respectively.

The forwarding (e.g., according to the first method aspect) of the first and second TSN data packets may comprise receiving either the first TSN data packets in the source cell using the first PDU sessions or the second TSN data packets in the target cell using the second PDU sessions at any point in time after completion of the establishing of the second PDU session in the target cell.

According to the switching from the first PDU session to the second PDU session (e.g., determined by the UP of the CN, optionally the UPF), the radio device may receiver either in first second PDU session or the second PDU session. A simultaneous reception (e.g., as in the case of a DAPS and/or in the case of forwarding DL data packets from the source access node to the target access node) may be excluded.

At least one or each of the first TSN data packets and the second TSN data packets (e.g., according to the first method aspect) may comprise packets of a packet data convergence protocol (PDCP) layer or packets of a service data adaptation protocol (SDAP) layer.

Herein, the expression “packet” may denote a packet data unit (PDU) or a service data unit (SDU).

Each of the first active protocol stack and the second protocol stack at the radio device (e.g., according to the first method aspect) may comprise user plane protocol layers of an access stratum (AS), optionally under a common layer for the switching from the first PDU session to the second PDU session.

Each of the first and second active protocol stacks (e.g., according to the first method aspect) may comprise an entity of a packet data convergence protocol (PDCP) layer. Alternatively or in addition, the common layer (e.g., according to the first method aspect) may comprise at least one of a service data adaptation protocol (SDAP) layer; a switching function for the stitching from the first PDU session to the second PDU session; and the DS-TT.

A single protocol entity of the SDAP may be configured for each of the first and second PDU sessions. Alternatively or in addition, the SDAP layer may comprise or provide at least one of the following functions (e.g., services). A first SDAP function may map between a QoS flow and a DRB. A second SDAP function may mark a QoS flow identifier (QFI) of a QoS flow in the TSN data packets, e.g., in both DL and UL packets.

The UP of the CN (e.g., according to the first method aspect) may comprise a user plane function (UPF) of the CN or at least one of a serving gateway (S-GW) and a packet gateway (P-GW) of the CN.

The TSN data packets received in the first PDU session (e.g., according to the first method aspect) may be provided by the UP of the CN to a source access node of the source cell. Alternatively or in addition, the TSN data packets received in the second PDU session (e.g., according to the first method aspect) may be provided by the UP of the CN to a target access node of the target cell.

The TSN data packets received in the second PDU session need not to be forwarded from the source access node of the source cell to the target access node of the target cell. The forwarding may comprise receiving the second TSN data packets in the second PDU session unbuffered from the target access node upon switching to the second PDU session.

After the establishing of the second PDU session and/or prior to the forwarding of the second TSN data packets, the radio device may transmit a sequence control message to the UP of the CN. The sequence control message may be indicative of a sequence number of the last first TSN data packets received in the first PDU session. Alternatively or in addition, the forwarding of the second TSN data packets (e.g., according to the first method aspect) may comprise at least one of receiving the TSN data packets in the second PDU session responsive to the sequence control message; and receiving the TSN data packets in the second PDU session starting with the second TSN data packets subsequent to the sequence number indicated in the sequence control message.

For example the radio device may refrain from transmitting a sequence number (SN, e.g. a PDCP SN) to the target access node.

The method (e.g., according to the first method aspect) may further comprise or initiate at least one of the steps of determining, at the radio device using traffic forwarding information, that an uplink TSN data packet received on an ingress port of the DS-TT is to be forwarded using the second or fourth QoS flow in the first or second PDU session; and when a downlink TSN data packet is received at the radio device, determining an egress port of the DS-TT based on the first or second PDU session in which the downlink TSN data packet was received at the radio device.

According to a second method aspect, a method of forwarding data packets at an access node serving in a source cell a radio device during a handover of the radio device from the source cell to a target cell of a radio network serving as a time-sensitive networking (TSN) bridge is provided. The method comprises or initiates the step of forwarding first TSN data packets in a first PDU session between the radio device and a user plane (UP), of a core network (CN), of the radio network. The method further comprises or initiates the step of determining the handover based on a measurement report received from the radio device. The method further comprises or initiates the step of transmitting a control message to the radio device, the control message being configured to trigger the radio device to establish a second PDU session in the target cell.

The access node (e.g., according to the second method aspect) may continue forwarding the first TSN data packets in a first PDU session between the radio device and the UP of the CN after the establishing of the second PDU session between the radio device and the UP of the CN in the target cell.

The control message (e.g., according to the second method aspect) may be indicative of at least one of the handover, the serving as a TSN bridge, a reduction of an interruption time during the handover, and separately using the first active protocol stack for the source cell and the second active protocol stack for the target cell.

The second method aspect may be implemented alone or in combination with any one of the claims in the list of claims, particularly the claims 23 to 26.

The second method aspect may further comprise any feature and/or any step disclosed in the context of the first method aspect, or a feature and/or step corresponding thereto, e.g., a receiver counterpart to a transmitter feature or step.

The method (e.g., according to the second method aspect) may further comprise the features or steps of any one of claims 2 to 22 or any feature or step corresponding thereto.

As to a third method aspect, a method of forwarding data packets at a user plane (UP) of a core network (CN) of a radio network during a handover of a radio device from a source cell to a target cell of the radio network serving as a time-sensitive networking (TSN) bridge is provided. The method comprises or initiates the step of forwarding first TSN data packets through the source cell using a first PDU session between the radio device and the UP of the CN. The method further comprises or initiates the step of establishing, prior to releasing the first PDU session, a second PDU session between the radio device and the UP of the CN in the target cell. The method further comprises or initiates forwarding second TSN data packets through the target cell using the second PDU session.

The establishing of the second PDU session may be in response to a PDU session request received from the radio device in the target cell.

The method (e.g., according to the third method aspect) may further comprise or initiate the step of transferring all TSN configuration information from the first PDU session to the second PDU session, optionally wherein the TSN configuration information comprises at least one of a forwarding configuration of the TSN bridge; a gate open time interval for the TSN bridge; and a TSC assistance information (TSCAI) for the TSN bridge.

The forwarding configuration may also be referred to as traffic forwarding information. The forwarding configuration may comprise or may be indicative of one or more traffic filters.

Receiving, at the UP in the CN, a first TSN data packet in the second PDU session may trigger switching from using the first PDU session to the second PDU session for all TSN data packets in the downlink received at a network-side TSN translator (NW-TT) during the next gate open time interval.

The third method aspect may be implemented alone or in combination with any one of the claims in the list of claims, particularly the claims 27 to 30.

The third method aspect may further comprise any feature and/or any step disclosed in the context of the first and/or second method aspect, or a feature and/or step corresponding thereto, e.g., a network counterpart to a radio device feature or step.

The method (e.g., according to the third method aspect), may further comprise the features or steps of any one of claims 2 to 26 or any feature or step corresponding thereto.

For example, any feature disclosed for the radio device or the first method aspect in relation to the DS-TT may be implemented, mutatis mutandis, for the UP (e.g., the UPF) in relation to the NW-TT.

As to another aspect, a computer program product is provided. The computer program product comprises program code portions for performing any one of the steps of the first, second and/or third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a radio device for forwarding data packets at the radio device during a handover of the radio device from a source cell to a target cell of a radio network serving as a time-sensitive networking (TSN) bridge is provided. The radio device comprises memory operable to store instructions and processing circuitry operable to execute the instructions. The radio device (e.g., according to the first device aspect) is operable to forward first TSN data packets in the source cell using a first PDU session between the radio device and a user plane (UP), of a core network (CN), of the radio network. The radio device is further operable to prior to releasing the first PDU session, establish a second PDU session between the radio device and the UP of the CN in the target cell. The first PDU session uses a first active protocol stack at the radio device and the second PDU session uses a second active protocol stack at the radio device. The radio device further is operable to forward second TSN data packets in the target cell using the second PDU session.

The radio device (e.g., according to the first device aspect), may further operable to perform the steps of any one of claims 2 to 22.

As to a further first device aspect, a radio device for forwarding data packets at the radio device during a handover of the radio device from a source cell to a target cell of a radio network serving as a time-sensitive networking (TSN) bridge is provided. The radio device is configured to forward first TSN data packets in the source cell using a first PDU session between the radio device and a user plane (UP), of a core network (CN), of the radio network. The radio device is further configured to establish, prior to releasing the first PDU session, a second PDU session between the radio device and the UP of the CN in the target cell. The first PDU session uses a first active protocol stack at the radio device and the second PDU session uses a second active protocol stack at the radio device. The radio device is further configured to forward second TSN data packets in the target cell using the second PDU session.

The radio device (e.g., according to the further first device aspect) may further be configured to perform the steps of any one of claims 2 to 22.

As to a still further first device aspect, a user equipment (UE) configured to communicate with an access node or with a radio device functioning as a gateway is provided. The UE comprises a radio interface and processing circuitry configured to forward first TSN data packets in the source cell using a first PDU session between the radio device and a user plane (UP) of a core network (CN) of the radio network. The UE comprises a radio interface and processing circuitry further configured to establish, prior to releasing the first PDU session, a second PDU session between the radio device and the UP of the CN in the target cell. The first PDU session uses a first active protocol stack at the radio device and the second PDU session uses a second active protocol stack at the radio device. The processing circuitry is further configured to forward second TSN data packets in the target cell using the second PDU session.

The processing circuitry of the UE (e.g., according to the still further first device aspect) may be further configured to execute the steps of any one of claims 2 to 22.

As to a second device aspect, an access node for forwarding data packets at the access node serving in a source cell a radio device during a handover of the radio device from the source cell to a target cell of a radio network serving as a time-sensitive networking (TSN) bridge is provided. The access node comprises memory operable to store instructions and processing circuitry operable to execute the instructions, such that the access node is operable to forward first TSN data packets in a first PDU session between the radio device and a user plane (UP) of a core network (CN) of the radio network. The access node is further operable to determine the handover based on a measurement report received from the radio device. The access node is further operable to transmit a control message to the radio device, the control message being configured to trigger the radio device to establish a second PDU session in the target cell.

The access node (e.g., according to the second device aspect) may be further operable to perform any one of the steps of any one of claims 23 to 26.

As to a further second device aspect, an access node for forwarding data packets at the access node serving in a source cell a radio device during a handover of the radio device from the source cell to a target cell of a radio network serving as a time-sensitive networking (TSN) bridge is provided. The access node is configured to forward first TSN data packets in a first PDU session between the radio device and a user plane (UP) of a core network (CN) of the radio network. The access node is further configured to determine the handover based on a measurement report received from the radio device. The access node is further configured to transmit a control message to the radio device, the control message being configured to trigger the radio device to establish a second PDU session in the target cell.

The access node (e.g., according to the further second device aspect), may further configured to perform the steps of any one of claims 23 to 26.

As to a still further second device aspect, a gNB configured to communicate with a user equipment (UE) is provided. The gNB comprises a radio interface and processing circuitry configured to forward first TSN data packets in a first PDU session between the radio device and a user plane (UP) of a core network (CN) of the radio network. The processing circuitry is further configured to determine the handover based on a measurement report received from the radio device. The processing circuitry further configured to transmit a control message to the radio device, the control message being configured to trigger the radio device to establish a second PDU session in the target cell.

The processing circuitry of the gNB (e.g., according to the still further second device aspect) may be further configured to execute the steps of any one of claims 23 to 26.

As to a third device aspect, a user plane (UP) for forwarding data packets at the UP of a core network (CN) of a radio network during a handover of a radio device from a source cell to a target cell of the radio network serving as a time-sensitive networking (TSN) bridge is provided. The UP is operable to forward first TSN data packets through the source cell using a first PDU session between the radio device and the UP of the CN. The UP is further operable to establish, prior to releasing the first PDU session, a second PDU session between the radio device and the UP of the CN in the target cell. The UP is further operable to forward second TSN data packets through the target cell using the second PDU session.

The UP (e.g., according to the third device aspect) may further be operable to perform the steps of any one of claims 28 to 30.

As to a further third device aspect, a user plane (UP) for forwarding data packets at the UP of a core network (CN) of a radio network during a handover of a radio device from a source cell to a target cell of the radio network serving as a time-sensitive networking (TSN) bridge is provided. The UP is configured to forward first TSN data packets through the source cell using a first PDU session between the radio device and the UP of the CN. The UP is further configured establish, to prior to releasing the first PDU session, a second PDU session between the radio device and the UP of the CN in the target cell. The UP is further configured to forward second TSN data packets through the target cell using the second PDU session.

The UP (e.g., according to the further third device aspect), may further configured to perform the steps of any one of claims 28 to 30.

As to a still further third device aspect, a user plane function (UPF) configured to communicate with an access node or with a radio device functioning as a gateway the UE comprising a radio interface and processing circuitry is provided. The UPF is configured to forward first TSN data packets through the source cell using a first PDU session between the radio device and the UP of the CN. The UPF is further configured to establish, prior to releasing the first PDU session, a second PDU session between the radio device and the UP of the CN in the target cell. The UPF is further configured to forward second TSN data packets through the target cell using the second PDU session.

The processing circuitry of the UPF (e.g., according to the still further third device aspect) may be further configured to execute the steps of any one of claims 28 to 30.

As to a system aspect, a communication system is provided. The communication system includes a host computer comprising processing circuitry configured to provide user data and a communication interface configured to forward user data to a cellular (or ad hoc) radio network for transmission to a user equipment (UE) is provided. The UE comprises a radio interface and processing circuitry, the processing circuitry of the UE being configured to execute the steps of any one of claims 1 to 22.

The communication system (e.g., according to the system aspect) may further include the UE.

In the communication system (e.g., according to the system aspect), the radio network may further comprise an access node (or a radio device functioning as a gateway) which is configured to communicate with the UE.

In the communication system (e.g., according to the system aspect), the access node (or the radio device functioning as a gateway) may comprise processing circuitry, which is configured to execute the steps of claims 23 to 26.

In the communication system (e.g., according to the system aspect), the processing circuitry of the host computer may be configured to execute a host application, thereby providing the user data; and the processing circuitry of the UE may be configured to execute a client application associated with the host application.

Alternatively or in addition, any aspect of the technique may be implemented as a method of switching a QoS flow during a change of the serving cell between two access node, e.g., during an inter-gNB cell change.

Alternatively or in addition, any aspect of the technique may be implemented according to or by extending the 3GPP document TS 23.501, version 16.7.0.

Without limitation, for example in a 3GPP implementation, any “radio device” may be a user equipment (UE). Any one of the method aspects may be embodied by a method of establishing a UE relaying connection with a desired QoS.

The technique may be applied in the context of 3GPP New Radio (NR) or 3GPP LTE. The technique may be implemented in accordance with a 3GPP specification, e.g., for 3GPP release 17.

In any radio access technology (RAT), the technique may be implemented for SL relay selection. The SL may be implemented using proximity services (ProSe), e.g. according to a 3GPP specification.

Any radio device may be a user equipment (UE), e.g., according to a 3GPP specification.

The radio device and/or the access node (e.g., a base station) and/or the RAN and/or the UP of the CN, or may be part of, a radio network, e.g., according to the Third Generation Partnership Project (3GPP) or according to the standard family IEEE 802.11 (Wi-Fi). The first method aspect, the second method aspect and third method aspect may be performed by one or more embodiments of the radio device, the access node (e.g., the RAN or a base station), and the UP, respectively.

The RAN may comprise one or more base stations, e.g., performing the third method aspect. Alternatively or in addition, the radio network may be a vehicular, ad hoc and/or mesh network comprising two or more radio devices, e.g., acting as the remote radio device and/or the relay radio device and/or the further remote radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more access nodes (e.g., base stations).

The access node may encompass any station that is configured to provide radio access to any of the radio devices. The access node may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Any one of the devices, the UE, the access nodes, the UP (e.g., the UPF), the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for forwarding data packets at a radio device;

FIG. 2 shows a schematic block diagram of an embodiment of a device for forwarding data packets at an access node;

FIG. 3 shows a schematic block diagram of an embodiment of a device for forwarding data packets at a user plane;

FIG. 4 shows a flowchart for a method of forwarding data packets at a radio device, which method may be implementable by the device of FIG. 1;

FIG. 5 shows a flowchart for a method of forwarding data packets at an access node, which method may be implementable by the device of FIG. 2;

FIG. 6 shows a flowchart for a method of forwarding data packets at a user plane, which method may be implementable by the device of FIG. 3;

FIG. 7 schematically illustrates a first example of a radio network serving as an TSN bridge and comprising embodiments of the devices of FIGS. 1, 2, and 3 for performing the methods of FIGS. 4, 5, and 6, respectively;

FIG. 8 schematically illustrates a second example of a radio network comprising embodiments of the devices of FIGS. 1, 2, and 3 for performing the methods of FIGS. 4, 5, and 6, respectively;

FIG. 9 schematically illustrates a signaling diagram resulting from embodiments of the devices of FIGS. 1, 2, and 3 performing the methods of FIGS. 4, 5, and 6, respectively, in communication;

FIG. 10 shows a schematic block diagram of a radio device embodying the device of FIG. 1;

FIG. 11 shows a schematic block diagram of an access node embodying the device of FIG. 2;

FIG. 12 shows a schematic block diagram of user plane embodying the device of FIG. 3;

FIG. 13 schematically illustrates an example telecommunication network connected via an intermediate network to a host computer;

FIG. 14 shows a generalized block diagram of a host computer communicating via a base station or radio device functioning as a gateway with a user equipment over a partially wireless connection; and

FIGS. 15 and 16 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

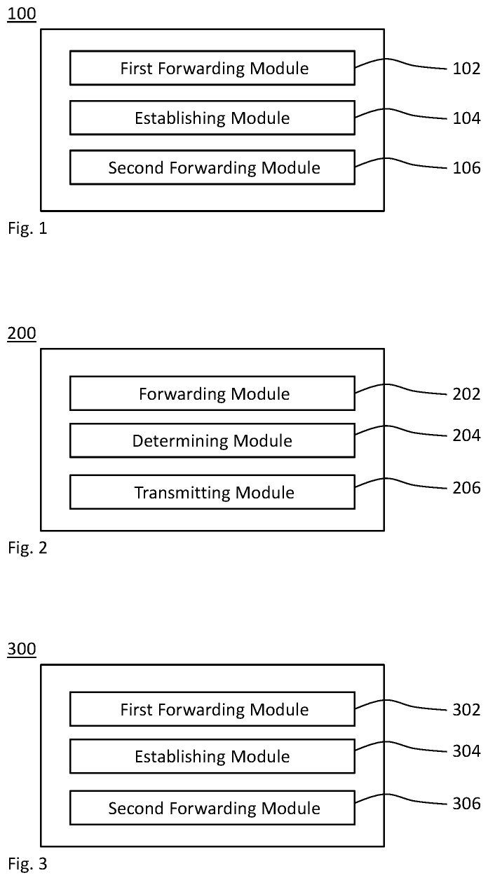

FIG. 1 schematically illustrates a block diagram of an embodiment of the first device aspect according to any of the claims 32 to 37. The device is generically referred to by reference sign 100.

The device 100 comprises modules 102, 104, and 106 indicated in FIG. 1 that perform correspond steps of the first method aspect to:
forward first TSN data packets in the source cell using a first PDU session between the radio device and a user plane (UP) of a core network (CN) of the radio network;
prior to releasing the first PDU session, establish a second PDU session between the radio device and the UP of the CN in the target cell, wherein the first PDU session uses a first active protocol stack at the radio device and the second PDU session uses a second active protocol stack at the radio device; and
forward second TSN data packets in the target cell using the second PDU session.

Any of the modules of the device 100 may be implemented by units configured to provide the corresponding functionality.

The device 100 may also be referred to as, or may be embodied by, a radio device (or briefly: UE). The UE 100 and the access node and/or the user plane of the CN direct radio communication or indirect communication.

FIG. 2 schematically illustrates a block diagram of an embodiment of the second device aspect according to any of the claims 38 to 43. The device is generically referred to by reference sign 200.

The device 200 comprises modules that perform correspond steps of the second method aspect.

The device 200 comprises modules 202, 204, and 206 indicated in FIG. 2 that perform correspond steps of the second method aspect to:
forward first TSN data packets in a first PDU session between the radio device and a user plane (UP) of a core network (CN) of the radio network;
determine the handover based on a measurement report received from the radio device; and
transmit a control message to the radio device, the control message being configured to trigger the radio device to establish a second PDU session in the target cell.

Any of the modules of the device 200 may be implemented by units configured to provide the corresponding functionality.

The device 200 may also be referred to as, or may be embodied by, the access node (or briefly: gNB or eNB).

FIG. 3 schematically illustrates a block diagram of an embodiment of the second device aspect according to any embodiment 44 to 49 in the list of embodiments. The device is generically referred to by reference sign 300.

The device 300 comprises modules that perform correspond steps of the third method aspect.

The device 300 comprises modules that perform correspond steps of the third method aspect.

The device 300 comprises modules 302, 304, and 306 indicated in FIG. 3 that perform correspond steps of the second method aspect to:
forward first TSN data packets through the source cell using a first PDU session between the radio device and the UP of the CN;
prior to releasing the first PDU session, establish a second PDU session between the radio device and the UP of the CN in the target cell; and
forward second TSN data packets through the target cell using the second PDU session.

Any of the modules of the device 300 may be implemented by units configured to provide the corresponding functionality.

The device 300 may also be referred to as, or may be embodied by, the use plane or user plane function (or briefly: UPF).

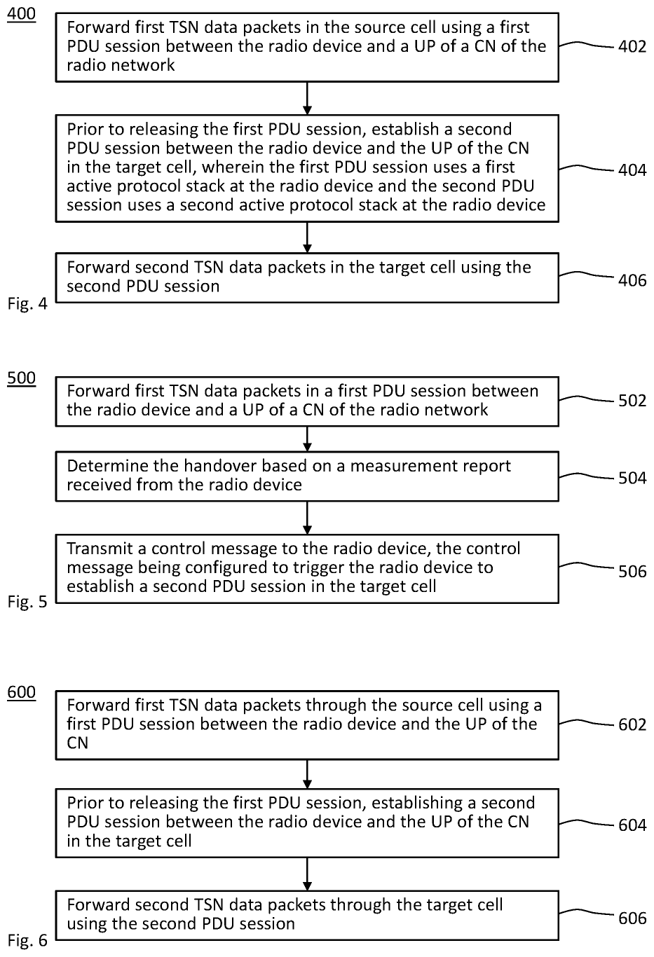

FIGS. 4, 5, and 6 show example flowcharts for the methods 400, 500 and 600, respectively, according to the first, second, and third method aspects, respectively and/or the claims 1, 23, and 27, respectively.

In any aspect, the technique may be applied to uplink (UL), downlink (DL) or direct communications between radio devices, e.g., device-to-device (D2D) communications or sidelink (SL) communications.

Each of the device 100 and device 200 may be a radio device and an access node (e.g., a base station), respectively. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

The handover may be triggered by a noise level or a signal-to-noise ratio (SNR) or a noise and/or interference or a signal-to-interference-and-noise ratio (SINR), e.g., based on measurements performed by the radio device 100 comparing the source cell 802 and the target cell 804.

Herein, the protocol data unit (PDU) session may encompass any (e.g., end-to-end) user plane (UP) connectivity between a radio device (e.g., UE) and a specific Data Network (DN) through a user plane of a core network (CN) of a radio network, e.g., through a user plane function (UPF) in a 5G core as the CN. The PDU session comprises (i.e., supports) one or more Quality of Service (QoS) flows. All TSN data packets belonging to a specific QoS flow have the same QoS, e.g., the same 5G QoS identifier (5QI).

In any embodiment, for configuration purposes, a TSN application function (AF) may determine Ethernet port pairs of a 5GS Bridge in order to identify the associated delay, e.g., according to 3GPP document TS 23.501, version 16.7.0, clause 5.27.5 on 5G System Bridge delay. For example, since residence times may vary among UEs and per traffic class, a delay between the UE and the UPF (or a corresponding network-side TSN translator, NW-TT) may vary among UPFs. In an embodiment, the TSN AF determines the delay caused by a 5GS Bridge after a PDU Session Establishment for the corresponding UPF and the radio device (e.g., UE). Optionally, the TSN AF deduces the related one or more port pairs from the port number of the DS-TT Ethernet port and the port number of the one or more NW-TT Ethernet ports of the same 5GS Bridge when the TSN AF receives the 5GS Bridge information for a newly established PDU Session. The TSN AF calculates and/or measures the bridge delays per port pair.

However, this determination of port pairs is not used for traffic forwarding. Instead, destination information within packets received on an Ethernet port of the NW-TT or the DS-TT is used for traffic forwarding decisions.

Time sensitive networking (TSN) translators are used when a radio network is functioning as a TSN bridge. In particular, each of a radio device (e.g., UE) and a user plane function (UPF) comprise a TSN translator, i.e., functionality which allows components of the radio network to interact with the remainder of the TSN deployment.

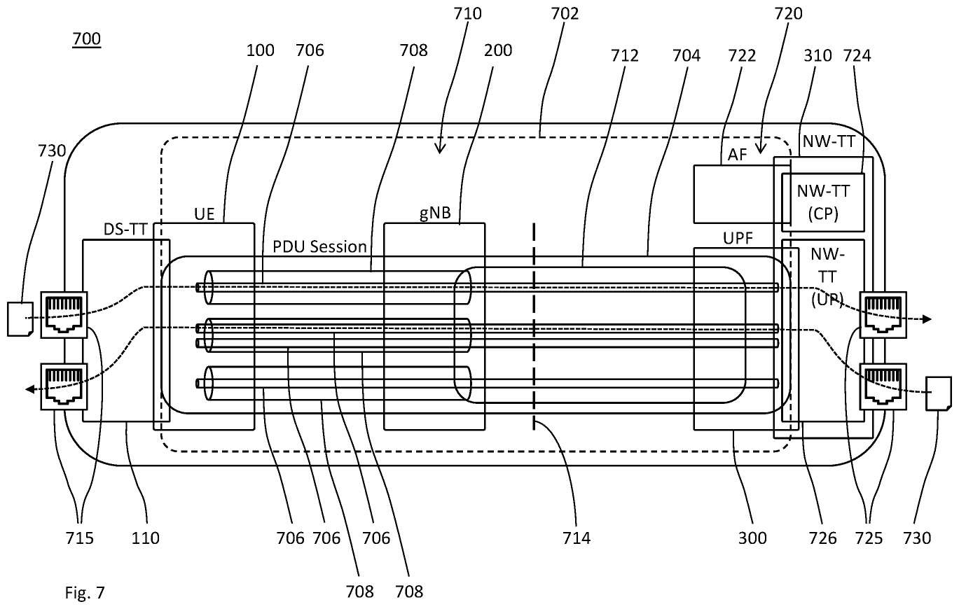

FIG. 7 schematically illustrates a TSN bridge 700 comprising a radio network 702, e.g., a Fifth Generation System (5GS). The radio network 702 comprises a radio access network (RAN) 710, e.g., according to 5G new radio (5G NR), and a core network (CN) 720, e.g., a 5G core (5GC). The radio network 702 provides at least one protocol data unit (PDU) session 704 between a radio device 100 serviced by the RAN 710 and a user plane function (UPF) 300 of the CN 720. The PDU session 704 comprises one or more QoS flows 706.

Each QoS flow 706 uses a data radio bearer (DRB) 708 for a radio link between the radio device 100 (e.g., a UE) attached to the RAN 710 and a access node 200 (e.g., a gNB) of the RAN 710. The access node 200 may map a QoS flows 706 to one more DRBs 708.

Each QoS flow 706 further uses a GTP-U tunnel 712 over an N3 interface 714 between the RAN 710 (e.g., the gNB 200) and the (e.g., initial) UPF 300 of the CN 720. The GTP-U tunnel 712 may use a GPRS tunneling protocol (GTP) for the user plane (GTP-U). The GTP-U may encapsulate a tunneling PDU to or from the radio device 100 on top of the protocol Internet Protocol (IP) and/or User Datagram Protocol (UDP).

There is a one-to-many relationship between the GTP-U tunnel 712 on the N3 interface 714 and the DRBs 708 on the radio interface Uu (i.e., for the radio link between radio device 100 and access node 200).

Each QoS flow 706 on the N3 interface 714 is mapped to a single GTP-U tunnel 712. Thus, the PDU session 704 may contain multiple QoS flows 706 and several DRBs 708 but only a single GTP-U tunnel 712.

Forwarding downlink (DL) traffic, i.e., at least one packet in the DL, through the radio network 702 as a TSN bridge 700 may comprise at least one of the following DL steps.

The core network (CN) 720, e.g., a user plane function (UPF) 300 of the CN 720, may examine destination information of a downlink packet (e.g., an Ethernet frame), which the UPF 300 receives on any given ingress NW-TT Ethernet port 725. The destination information may comprise a destination Ethernet MAC address and/or, if present, a virtual local area network (VLAN). The CN 720, e.g., the UPF 300, uses its traffic forwarding information to identify an egress DS-TT port 715 to forward the packet 730 to. In other words, the UPF 300 forwards the packet 730 using the UE-specific PDU session 704 associated with the identified egress DS-TT port 715.

A first DL step comprises a TSN application function (TSN AF) 722 configuring the CN 720 (e.g., the UPF 300 of the CN 720) with traffic forwarding information so the CN 720 (e.g., the UPF 300) is configured to associate each downlink packet 730 received on an ingress port 725 (e.g., an Ethernet port) of a network-side TSN translator (NW-TT) 310 with a specific PDU session 704 and QoS flow 706. For example, a destination Ethernet MAC address and VLAN of a downlink Ethernet packet 730 received on a NW-TT port 725 maps to a specific PDU session 704 and the traffic forwarding information (e.g., traffic filtering information) available at the UPF 300 is then used to further map the packet 730 to a specific QoS flow 706 in the PDU session 704.

The NW-TT 310 may comprise a component 724 for the control plan (CP), e.g., at the AF 722, and a component 726 for the user plane (UP), e.g., at the UPF 300.

A second DL step comprises the CN 720 (e.g., the UPF 300) receiving a set of QoS characteristics for each QoS flow supported within the context of any given PDU session 704, e.g., according to the 3GPP document TS 23.501, version 16.7.0, clause 5.7.3 and/or according to the below description of QoS characteristics.

A third DL step comprises mapping each downlink packet 730 to be forwarded using a given PDU session 704 to a specific value of a QoS flow identifier (QFI) identifying the appropriate QoS flow, inserting the QFI value in the GTP-U tunnel header and forwarding it to the gNB using a GTP-U PDU.

A fourth DL step comprises the RAN 710 (e.g., gNB 200) using the QFI within a header of the GTP-U to determine which DRB 708 within the corresponding PDU session 704 to use for packet transmission.

A fifth DL step comprises the RAN 710 (e.g., the gNB 200) receiving (e.g., being configured with) QFI-specific QoS characteristics, e.g., for each QoS flow supported within the context of any given DL PDU session 704. Accordingly, the gNB 200 may, for each QoS flow 706, configure a DRB 708 comprising either a periodic radio resource using semi-persistent scheduling (SPS) or a dynamically allocated radio resource. The gNB 706 may uses the radio resource to relay each DL packet 730 associated with that QoS flow 706.

A sixth DL step comprises the radio device 100 (e.g., UE) forwarding a DL packet 730 received on a QoS flow 706 of a given PDU session 704 to the DS-TT port 715, e.g., for further distribution to a target end station. All the traffic 730 coming from a PDU session 704 may be delivered to its unique associated DS-TT port 715.

Forwarding uplink (UL) traffic, i.e., at least one packet in the UL, through the radio network 702 as a TSN bridge 700 may comprise at least one of the following UL steps.

A radio device 100 (e.g., a UE) forwards an uplink packet 730 received on an ingress DS-TT port 715 of a DS-TT 110 using the PDU session 704 associated with that ingress DS-TT port 715. For example, the packet 730 (e.g., the Ethernet frame) is received on a Ethernet port 715 of the DS-TT 110 and the UE 100 always forwards it to the UPF 300 using the PDU session 704 associated with the ingress DS-TT port 715, regardless of the destination Ethernet MAC address (and VLAN if present) of the packet 730.

In a first UL step, each port 715 at the radio device 100 and/or the DS-TT 110 is configured and/or associated with a single PDU session 704 and traffic forwarding information (e.g., traffic filter information) so the UE 100 is configured to associate each uplink packet 730 received on a given ingress DS-TT port 715 with a specific PDU session 704 and a QoS flow 706. In other words, the DS-TT port 715 on which an uplink Ethernet packet 730 is received maps to a specific PDU session 704. Traffic forwarding information available at the UE 100 is then used to further map the packet 730 to a specific QoS flow 706.

In a second UL step, configuration information at the radio device 100 (e.g., UE) is indicative of a set of QoS flows established for use within the context of a given PDU session 704, e.g., as a result of a QoS flow establishment performed using QoS characteristics. The radio device 100 maps each (e.g., supported) uplink packet 730 using that PDU session 704 to a specific QoS flow 706 of (i.e., within) the PDU session 704.

In a third UL step, the gNB 200 is configured with QFI-specific QoS characteristics for each QoS flow 706 supported within the context of any given uplink PDU session 704. For each QoS flow 706, the gNB 200 configures a DRB 708 comprising either a periodic resource according to a configured grant (CG) or a dynamically allocated radio resource. The gNB 200 uses the radio resource to relay each UL packet associated with that QoS flow 706.

In a fourth UL step, upon receiving an UL packet 730, the gNB 200 inserts the corresponding value of the QFI in the header of the GTP-U tunnel (i.e., in the header of a PDU of the GTP-U) and forwards the GTP-U PDU to the UPF 300.

In a fifth UL step, the UPF 300 forwards an uplink packet 730 received on a QoS flow 706 of a given PDU Session 704 to the corresponding NW-TT port 725 based on traffic forwarding information available (e.g., stored) at the UPF 300. For example, the UPF 300 uses traffic forwarding information, the destination MAC address of the packet 730, and VLAN of the packet 730 to forward it towards a specific egress Ethernet port of the NW-TT 310.

In any one of the DL steps and/or UL steps, the QoS characteristics may be defined according to, or in extension of, the 3GPP document TS 23.501, version 16.7.0, clause 5.7.3, e.g., clause 5.7.3.1. Examples of the QoS characteristics are described below for a 5GS, which are also referred to as 5G QoS characteristics, for concreteness without limitation thereto. Alternatively or in addition, at least some or each of the (e.g., 5G) QoS characteristics may be associated with a 5G QoS Indicator (5QI).

The forwarding of a packet (also referred to as packet forwarding treatment) may depend on the QoS characteristics of the respective packet. The QoS characteristics may be associated with a QoS flow 706. The QoS characteristics may determine the forwarding of the packet 730 in a QoS flow 706, e.g., edge-to-edge between the radio device 100 (e.g., UE) and the core network 720 (e.g., the UPF 300), optionally in terms of at least one of the following performance characteristics.

A first performance characteristic is a resource type, e.g. including at least one of guaranteed bit rate (GBR), delay-critical GBR, and Non-GBR. A second performance characteristic is a priority level. A third performance characteristic is a packet delay budget (PDB), e.g., including a core network packet delay budget for the core network (CN). A fourth performance characteristic is a packet error rate (PER). A fifth performance characteristic is an averaging window, e.g., only for the resource types GBR and Delay-critical GBR and/or applied for one or more other performance characteristics. A sixth performance characteristic is a maximum data burst volume, e.g., only for the resource type relay-critical GBR.

The 5G QoS characteristics may be used as guidelines for setting node-specific parameters (e.g., specific for the radio device) for each QoS flow, e.g. for a configuration of a (e.g., 3GPP) radio access link layer protocol. Preferably, standardized or pre-configured 5G QoS characteristics are indicated through the value 5QI, and are not signaled on any interface, unless certain 5G QoS characteristics are modified, e.g., as specified in clauses 5.7.3.3, 5.7.3.4, 5.7.3.6, and 5.7.3.7 of the 3GPP document TS 23.501, version 16.7.0.

Preferably, as there are no default values specified, pre-configured 5G QoS characteristics include all of the characteristics listed above. Alternatively or in addition, 5G QoS characteristics may be signaled as part of a QoS profile and/or may include all of the characteristics listed above.

The configuration information and/or the traffic forwarding information may comprise TSC assistance information according to Table 5.27.2-1 of the 3GPP document TS 23.501, version 16.7.0 and/or according to the below table.

| Assistance Information | Description |
|---|---|
| Flow Direction | The direction of the TSC flow (uplink or |
| | downlink). |
| Periodicity | It refers to the time period between start of |
| | two bursts. |
| Burst Arrival time | The latest possible time when the first |
| | packet of the data burst arrives at either the |
| | ingress of the RAN (downlink flow direction) |
| | or egress interface of the UE (uplink flow |
| | direction). |

The TSC assistance information (TSCAI) may be a further performance characteristic of the QoS flow 706 and/or may be (e.g., stored and transmitted) outside of level parameters for the QoS flow.

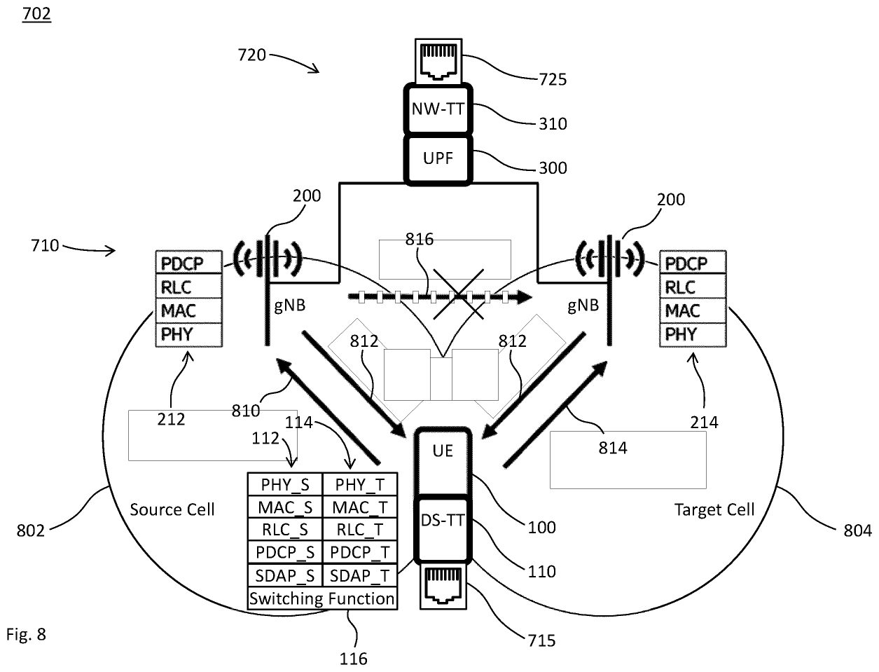

The first active protocol stack 112 and the second active protocol stack 114 may be simultaneously active at the radio device 100 in a dual active protocol stack (DAPS) during the handover. In any embodiment, the handover using the DAPS may comprise at least one of the following handover steps (e.g., any one of the five handover steps and/or any one of the handover steps illustrated at reference signs 810 to 816 in FIG. 8).

Herein, the expression “user data” and “data packet” may encompass a PDCP data packet or an SDAP data packet.

In a conventional inter-node handover, the UE typically releases the connection to the source cell 802 before the link to the target cell 804 is established, i.e., uplink and downlink transmission is stopped in the source cell 802 before the conventional UE starts to communicate with the target cell 804. This typically causes an interruption in the transmission of user data in the UL and DL in the range of a few tens of milliseconds.

To enable, or ensure performance in, e.g., emerging 5G wireless use cases such as factory automation or transport industry, an interruption time caused by the handover can be reduced close to zero milliseconds or eliminated using the DAPS. The handover using the DAPS (briefly: DAPS handover) may be implemented as specified in 3GPP Release 16, e.g., for the radio network 702 providing radio access according to the fourth generation (4G, e.g. using 4G LTE for the RAN 710 and an evolved packet core, EPC, for the CN 720) and/or for the radio network 702 providing radio access according to the fifth generation (5G, e.g., using 5G NR for the RAN 710 and the 5GC for the CN 720). The handover may also be referred to as a handover procedure.

The radio device 100 (e.g., UE) may be configured to continue DL reception and/or UL transmission in the source cell 802 while completing the connection to the target cell 804.

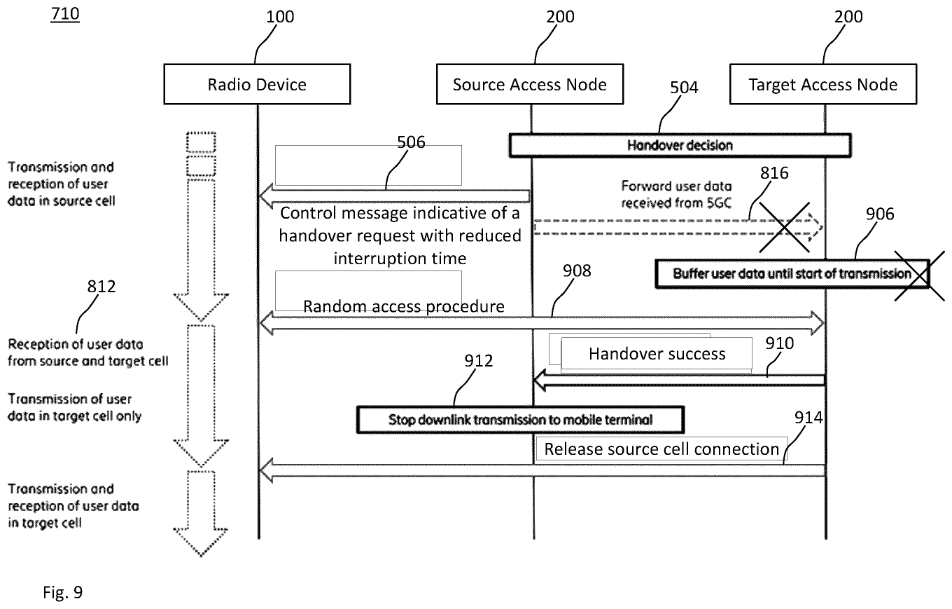

In a first handover step 810, transmission and/or reception of user data in the source cell 802 continues after transmitting, from the source access node 200 or receiving at the radio device 100, a handover request (e.g., at reference sign 504 in FIG. 9) indicative of a handover while serving as an TSN bridge, i.e., a handover request instructing the radio device 100 to establish a coexisting second PDU session during the handover. For example, data packets 730 of the SDAP layer and/or the PDCP layer are transmitted in the UL in the source cell 802 until completion of a random access procedure in the target cell 804.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

In a second handover step 812, user data is received from both the source cell 802 and the target cell 804 (e.g., simultaneously) upon and/or after completion of a random access procedure in the target cell 804.

In a third handover step 814, UL transmission of user data is switched from the source cell 802 to the target cell 804 after completion of the random access procedure in the target cell 804 and after establishing 404 the second PDU session 704. Data packets 730 (e.g., of the SADP and/or PDCP layer) are transmitted in the UL (e.g., exclusively) in the target cell 804 not necessarily directly after completion of the random access procedure and the session establishment 404, but in synchronization with the operation of the TSN bridge 700.

In a fourth handover step, a connection to the source cell 802 is released at (e.g., upon) reception of a release indicator from the target access node 200 of the target cell 804.

When the handover has been determined (i.e., decided), it is the UE 100 or the UPF 300 that determines the switching, so that the source access node 200 does not have to forward copies of the TSN data packets 730 to the target access node 200 according to the conventional step 816.

FIG. 8 schematically illustrates an embodiment of a radio device 100, of access nodes 200 and a UPF 300 of a radio network 702, each of which is configured for a handover of the radio device 100 according to the technique, preferably avoiding a dual active protocol stack (DAPS), which is briefly referred to as DAPS handover. While the handover technique is illustrated for the embodiment of FIG. 8, the features illustrated in FIG. 8 and/or described with reference to FIG. 8 may be implemented in any other embodiment and any aspect.

Upon receiving the control information indicative of a request to perform the handover while serving as an TSN bridge 700, the UE 100 continues to transmit and/or receive user data in the source cell 802 according to the step 810 while establishing a further radio connection to the target access node 200 in the target cell target 804.

The UE 100 establishes a second active protocol stack 114 for the target cell 804, e.g., for the second PDU session 704. The second active protocol stack 114 may be or may comprise a user plane (UP) protocol stack. Alternatively or in addition, the second active protocol stack 114 may comprise all layers of an access stratum and/or at least one of a physical layer (PHY layer or L1), a medium access control layer (MAC layer or L2), a radio link control layer (RLC layer), packet data convergence protocol (PDCP) layer, and a service data adaptation protocol (SDAP) layer. The second active protocol stack 114 may also be referred to as a target UP protocol stack.

While establishing the second active protocol stack 114 and/or the second PDU session 704, a first active protocol stack 112 is maintained (i.e., kept active) for transmission and/or reception of user data (i.e., TSN data packets) in the source cell 802. The first active protocol stack 112 may comprise or may be a UP protocol stack. The first active protocol stack 112 may also be referred to as a source UP protocol stack.

The layers of the first active protocol stack 112 may correspond (e.g., one by one) to the layers of a protocol stack 212 at the source access node 200 serving the source cell 802. Alternatively or in addition, the layers of the second active protocol stack 114 may correspond (e.g., one by one) to the layers of the protocol stack 214 at the target access node 200 serving the target cell 804.

Optionally, the radio device 100 or the associated DS-TT 110 comprises a common layer 116 (e.g., atop of the AS protocol layers) for determining when to switch from using the first PDU session to using the second PDU session (i.e., a switching function, briefly referred to as the switching).

Preferably, in contrast to conventional DAPS, the UE 100 does not receive TSN data packets (e.g., user data) simultaneously from both the source cell 802 and the target cell 804. The common layer 116 may be a transient entity for the source user plane protocol stack 112 and the target user plane protocol stack 114 active for a duration equal to or on the order of a packet delay budget (PDB)s of the TSN bridge 700.

Preferably, e.g., to secure in-sequence delivery of user data, (other than a PDCP sequence number (SN) continuation being maintained throughout the handover by a common re-ordering and duplication function) the switching at the UE 100 for the UL and/or at the UPF 300 for the DL may ensure a unique order for the source cell 802 (e.g., for the first PDU session 704) and the target cell 804 (e.g., for the second PDU session 704).

Alternatively or in addition, at least one of ciphering, deciphering, header compression, and header decompression are handled separately in the PDCP layer, e.g., depending on an origin and/or a destination of the (e.g., DL or UL) data packet 730.

User data (e.g., TSN data packets 730) received from the CN 720 is transmitted to the radio device 100 (e.g., UE) in the source cell 802. Furthermore, according to a fifth handover step 814, the user data (e.g., the TSN data packets 730) received from the CN 720 is forwarded to the target access node 200 of the target cell, e.g., the target access node 200 controlling (i.e., serving and/or scheduling) the target cell 804.

The forwarded user data (e.g., TSN data packets 730) may be buffered in the target access node 200 until DL transmission is started using the second PDU session 704, e.g., once the radio device 100 has successfully accessed the target cell 804. After the random access procedure of the radio device 100 is completed in the target cell 804, the radio device 100 switch its UL transmission of user data (e.g., TSN data packets 730) from the source cell 802 to the target cell 804 and informs the target access node 200 of the last received PDCP SN in the source cell 802. Based on this information, the target access node 200 performs duplication detection of the buffered user data (e.g., TSN data packets 730) before starting the DL transmission to the radio device 100.

FIG. 9 schematically illustrates a signaling diagram, preferably avoiding the delay caused conventionally by a Dual Active Protocol Stack (DAPS) handover, resulting from embodiments of the radio device 100 and the source and target access nodes 200 in radio communication.

Herein, for concreteness and without limitation thereto, the radio device 100 is described as a UE. The source and target access nodes are, for concreteness and without limitation thereto, described as source and target gNBs.

The handover may, e.g., alternatively or in addition to the above-mentioned handover steps, comprise at least one of the following handover steps.

In a handover step 504, at least one of the source access node 200 and the target access node 200 determines upon at least one of the handover, the TSN, and the usage of the dual connectivity (e.g., instead of the DAPS).

In a handover step 904, the control message indicative of at least one of the handover, the TSN, and the usage of the subject technique is transmitted from the source access node 200 to the UE 100. Herein, a reference sign of a step may also refer to a message associated with the step.

The conventional handover step 816, i.e., the TSN data packets 730 received from the CN 720 at the source access node 200 being forwarded to the target access node 200, can be omitted. Furthermore, the target access node 200 does not use a buffer 906 for temporarily storing the TSN data packets forwarded by the source access node 200 until the second PDU session is established in the step 404.

As a substep of the step 404, the UE 100 performs a random access procedure 908 in the target cell 804. The substep 908 may comprise the UE 100 transmitting a random access preamble to the target access node 200 and/or the target access node 200 transmitting a random access response to the UE 100.

After the UE 100 has successfully accessed the target cell 804, the target access node 200 informs the source access node 200 of the successful handover by sending the Handover Success message 910, e.g., over an Xn interface for control signaling (Xn-C).

Responsive to the Handover Success message 910, the source access node 200 stops transmitting using the first PDU session 704 in a step 912. For example, reception of the Handover Success message 910 triggers the source access node 200 to stop its DL transmission 812 to the UE 100. Data forwarding of DL and UL data and path switch request of DL data may follow a regular inter-node handover procedure.

The target access node 200 (e.g., subsequently to the Handover Success message 910) instructs the UE 100 to release its connection to the source cell 802 in a step 914.

Any embodiment may be applied to the case of a 5GS as the radio network 702 acting (e.g., serving) as a TSN bridge 700 within a TSN network. A single UPF 300 may exists with connectivity to multiple gNBs 200 within the 5GS 702.

For a Dual Active Protocol Stack (DAPS) as a feature of a handover from a source cell 802 to a target cell 804, e.g., in support of inter-gNB cell change, requires that downlink packets 730 are transmitted from the source gNB 200 (i.e., gNB1) to the UE 100 directly by using radio resources in the source cell 802 (also denoted by cell 1) served by source gNB 200 (i.e., gNB1). Furthermore, the DAPS handover requires that the downlink packets 730 are transmitted indirectly by forwarding packets 730 from the source 200 (i.e., gNB1) to the target gNB 200 (i.e. gNB2), e.g., using the Xn interface for the user plane (also referred to as Xn-U interface), according to the step 816, and then transmitting the packets 730 using radio resources scheduled by the target gNB 200 (i.e., gNB2) in the target cell 804 (also denoted by cell 2) once the UE 100 has completed the cell change to the target cell 804.

Using DAPS during the handover may imply that the UE 100 receives downlink packets 730 using a single packet data convergence protocol (PDCP) entity 116 that interworks with a first active protocol stack 112 comprising layers RLC, MAC and PHY for receiving of packets 730 in the source cell 802 (i.e., cell 1) and a second active protocol stack 114 comprising layers RLC, MAC and PHY for receiving of packets 730 in the target cell 804 (i.e., cell 2).

The routing of downlink packets 730 received from a TSN network by the 5GS 702 serving as a TSN bridge 700 requires the use of a QoS flow 706. The QoS flow 706 comprises a GTP-U tunnel 712 (i.e., a GTP-U connection) between a UPF 300 and a gNB 200 and a DRB 708 (i.e., a DRB resource) between the gNB 200 and a UE 100, e.g., as illustrated in FIG. 7 or described with reference to FIG. 7.

Using the conventional routing of DL packets 730, which is based on one or more QoS flows 706, before, during and after a cell change excludes the possibility of having any time period during which DL packets 730 are relayed using a path from a source access node 200 of the source cell 802 (e.g., a gNB1) to a target access node 200 of the target cell 804 (e.g., a gNB2). In addition, delays introduced when relaying packets 730 from the source access node 200 of the source cell 802 (e.g., gNB1) to the target access node 200 of the target cell 804 (e.g., gNB2) due to e.g., handover, may not be acceptable in TSN, since the delays may result in a total packet delay introduced by the 5GS 702 exceeding its allocated Packet Delay Budget (PDB).

The technique may be implemented using the switching (e.g., a routing) based on the first and second PDU sessions 704 (also referred to as PDU session centric routing) and/or based on the QoS flows 706 (also referred to as QoS flow centric routing) of the TSN data packets 730.

The radio device 100 (e.g., the switching function 116) may determine the switching between the first and second PDU sessions and/or the QoS flows for TSN data packets 730 in the UL. Alternatively or in addition, the UP 300 (e.g., the UPF 300) may determine the switching between the first and second PDU sessions and/or the QoS flows for TSN data packets 730 in the DL.

A conventional forwarding 816 of downlink packets associated with 5GS-TSN network inter-working for using a conventional DAPS handover centric routing of downlink packets during cell change can be avoided.

The technique may also be implemented to avoid packet forwarding from the source access node (e.g., gNB1) to the target access node (e.g., gNB2) during a regular inter-node (non-DAPS) handover, which is likely to be more common in 5G deployments (i.e. since DAPS handover was introduced in Release 16 and deployments using DAPS handover is expected to be rare due to the complexity it brings to the network and to the UE).

The switching performed and/or determined by the radio device 100 for UL transmission of TSN data packets 730 and/or the switching performed and/or determined by the UP 300 of the CN 720 (e.g., the switching performed and/or determined by the UPF 300) for DL transmission of TSN data packets 730 from the first PDU session to the second PDU session during the (e.g., inter-node) handover may be synchronized with serving as the TSN bridge 700. No packet forwarding from gNB1 to gNB2 has to start at transmission of the configuration message comprising the handover command (e.g., the RRCReconfiguration message) from gNB1 to the UE. For example, the switching may be determined by the CU 300 and the UE 100 for a point in time after the second PDU session 704 is established and/or until an end marker packet is transmitted by the CU 300 or the UE 100 (in the step 402 to the source access node 200), respectively.

While below embodiments are described for the inter-gNB cell change as an example of the handover from the source access node 200 to the target access node 200 in a 5GS for clarity and concreteness, the embodiments can be readily implemented for other radio network 702, e.g., a 4G evolved packet system (EPS).

Furthermore, while embodiments for the radio device 100 (e.g., UE) and the UP 300 of the CN 720 (e.g., UPF) and the access nodes 200 are described in combination, the skilled person understands which features are present at each of radio device 100 and the UP 300 and the access nodes 200, so that these are disclosed individually.

The case of a 5GS 702 serving as a TSN bridge 700 within a TSN network is considered. It is assumed that a single UPF 300 exists with connectivity to multiple gNBs 200 within the RAN 710 of the 5GS 702. This leads to the possibility of inter-gNB cell change as follows.

A UE 100 managed (e.g., served) by gNB1 200 in cell 1 (i.e., the source cell 802) can be configured with one or more uplink and downlink DRBs 708, wherein a given downlink DRB may comprise a SPS resource supporting a downlink QoS flow 1 (e.g., according to reference sign 706) and a given uplink DRB may comprise a CG resource supporting an uplink QoS flow 2 (e.g., according to reference sign 706), wherein both QoS flow 1 and QoS flow 2 are supported within the PDU session 1 (i.e., the first PDU session) in cell 1.

The UPF 300 uses traffic forwarding information to determine that a downlink Ethernet packet (received on an ingress port of the NW-TT 310) with destination MAC address X is to be forwarded using downlink QoS flow 1 within PDU session 1.

The UE 100 uses traffic forwarding information to determine that an uplink packet (received on an ingress port of the DS-TT) is to be forwarded using uplink QoS flow 2 within PDU session 1.

When a downlink TSN data packet 730 is received at the UE 100, the egress Ethernet port 715 of the DS-TT is determined based on the corresponding PDU session 704 (i.e. the PDU session 704 on which the packet 730 was received at the UE 100).

When an uplink packet is received at the UPF, the UPF decides which NW-TT port 725 it shall be forwarded to based on the traffic forwarding information.

As part of the cell change procedure (i.e., the handover), the UE 100 is allocated a downlink SPS resource for QoS flow 3 (i.e., the third QoS flow) and an uplink CG resource for QoS flow 4 (i.e., the fourth QoS flow), wherein both QoS flow 3 and 4 are supported within PDU session 2 (i.e., the second PDU session) in cell 2 (i.e., the target cell).

While supporting UL and DL data transmissions using PDU session 1 for a UE 100 in cell 1 (i.e., in the serving cell), the need for a cell change is detected by the gNB1 200. The following measurement events may be performed or initiated (i.e., triggered). A first measurement event comprises the gNB1 (i.e., the source access node 200) transmitting to the UE 100 a request for neighbor cell information. The UE 100 performs quality measurements, e.g., on Beam Reference Signals (BRSs), received from neighbor cells including the target cell 804. A second measurement event comprises the UE 100 transmitting a measurement report to the gNB1. The gNB1 selects the target cell 200 (i.e., cell 2) based on the received measurement report.

The gNB1 200 is aware that the UE 100 is currently supported using QoS flows 706 used for relaying uplink and downlink TSN traffic and can therefore trigger the following handover events. A first handover event comprises the gNB1 transmitting an RRC message 506 indicating the UE 100 is to proceed with PDU session establishment in the target cell 804 (managed by gNB2). A second handover event comprises the UE 100 transmitting a PDU session establishment request to the gNB2 200 in the target cell 804 (i.e., cell 2), thereby triggering establishment 404 of PDU session 2 comprising QoS flows 3 and 4. A third handover event uses dual connectivity allowing the UE 100 to perform the signaling required to establish 404 the PDU session 2 in cell 2 while continuing to support UL and DL data transmissions using PDU session 1 in cell 1. A fourth handover event comprises continuing (e.g., proceeding) the forwarding (e.g., transferring) of the TSN data packets (e.g., user plane payload) using either cell 1 (via gNB1) according to the step 402 or using cell 2 (via gNB2) according to the step 406, optionally whereby the UE 100 experiences a type of dual-connectivity for which neither gNB1 or gNB2 needs to be in control.

Before packet transfer may begin in cell 2, the CN 720 may be informed of the need for the PDU session 2, so that it can transfer all the TSN configuration information (including traffic forwarding information and traffic filters) from PDU session 1 to PDU session 2. This allows for associating the same DS-TT port 715 with the second PDU session 704.

After the uplink CG resource and GTP-U tunnel required for QoS flow 4 (i.e., the fourth QoS flow 706) are configured, the UE 100 can start using the second PDU session 704, e.g., the fourth QoS flow 706 (e.g., instead of the second QoS flow 706, i.e., QoS flow 2 and/or the first PDU session 704) to transmit uplink Ethernet packets as the TSN data packets 730 to the UPF 300.

The point at which a UE 100 switches from using QoS flow 2 to using QoS flow 4 can be synchronized with Qci gate open time intervals and/or TSCAI corresponding to QoS flows 2 and 4, e.g., according to at least one of the following synchronization steps.

The Qci may relate to a standard IEEE 802.1Qci and/or any standard for Local and Metropolitan Area Networks, e.g., for Media Access Control (MAC) Bridges and/or Virtual Bridged Local Area Networks Amendment and/or Per-Stream Filtering and Policing.

According to a first synchronization step, each member of the set of uplink packets 730, which the UE 100 may transmits using each instance of a periodic CG resource, is received by a DS-TT 110 within the context of a specific Qci gate open cycle. This means that if the UE 100 selects QoS flow 2 (i.e., in cell 1) for transmitting a first set of uplink packets it receives during Qci cycle K according to the step 402, then the UE 100 must complete the transmission of those TSN data packets 730 using QoS flow 2 according to the step 402. The transmission 402 must be completed using the first PDU session even if the QoS flow 4 of the second PDU session 704 becomes available during the transmission 402 of the first set of packets. The UE 100 can, at the earliest, begin using the second PDU session according to the step 406 for transmitting the set of uplink packets, which the DS-TT 110 receives during Qci cycle K+1.

In other words, all uplink packets a UE receives within a given time interval 1 (e.g. starting from Burst Arrival Time 1 and ending at the deadline for accumulating packets to be sent using a common MAC PDU) are sent using QoS flow 2 and all uplink packets it receives within time interval 2 (i.e. the next time interval starting at Burst Arrival Time 2) are sent using QoS flow 4.

There will be no need for duplication of uplink packets at the PDCP layer since the UE knows the last packet it received within time interval 1 to be sent using QoS flow 2 and therefore knows the first packet it received within time interval 2 that can be sent using QoS flow 4. This means that PDCP frame number continuity can be realized when cell change involves a change of gNB since the last uplink packet sent using QoS flow 2 has PDCP sequence number N and the first uplink packet sent using QoS flow 4 can be configured to have PDCP sequence number N+1 (i.e. the UE uses different PDCP protocol entities for QoS flow 2 and QoS flow 4).

According to a second synchronization step, the UPF 300 can assume that, upon reception of the first packet transmitted using according to the step 406, e.g., using the QoS flow 4 in the second PDU session 704, it will have either (a) already received and forwarded the last packet the UE sent using QoS flow 2 or (b) the last packet sent using QoS flow 2 was lost (i.e. the corresponding Packet Delay Budget (PDB) is exceeded).

Reception of the first packet on QoS flow 4 can therefore allow the UPF 300 to release the GTP-U tunnel used for uplink QoS flow 2 which can then trigger gNB1 to release the corresponding DRB resource.

In any embodiment, all uplink packets (i.e., TSN data packets in the uplink) to be transmitted using a given instance of a CG resource may be delivered according to a target Packet Error Rate (PER) within a corresponding Packet Delay Budget (PDB). This means that radio resources for QoS flow 2 in cell 1 (used for transmitting uplink packets received within time interval 1) can be made available for at least as long as the PDB applicable to QoS flow 2 in cell 1 (after which they can be safely released by gNB1 regardless if the MAC PDU was successfully delivered over the radio interface).

Similarly, the UPF 300 may start transmitting downlink packets the second PDU session 704, e.g., using the QoS flow 3, according to the step 606 at any point after the corresponding GTP-U tunnel and downlink SPS resource have been configured. The point at which a UPF switches from using QoS flow 1 to using QoS flow 3 can be synchronized with Qci gate open time intervals and/or TSCAI corresponding to QoS flows 2 and 4 as follows.

According to a third synchronization step, each member of the set of downlink packets, which the UPF 300 may transmit using each instance of a periodic SPS resource, is received by a NW-TT 310 within the context of a specific (e.g., Qci) gate open cycle. This means that if the UPF 300 selects QoS flow 1 (in cell 1) for transmitting a first set of downlink packets it receives during the (e.g., Qci) gate open cycle X, then it must complete transmission of those packets using QoS flow 1 (i.e. even if QoS flow 3 becomes available during the transmission of the first set of packets). The gNB 200 can, at the earliest, begin using it for transmitting the set of downlink packets, which the NW-TT 310 receives during the (e.g., Qci) gate open cycle X+1.

In other words, all downlink packets a UPF 300 receives during a (e.g., Qci) gate open time interval 1 map to the first PDU session and/or QoS flow 1 according to the step 602 and are therefore all sent to gNB1 200. All downlink packets gNB1 receives within time interval 1 (e.g. starting from Burst Arrival Time 1 and ending at the deadline for accumulating packets to be sent using a common MAC PDU) are sent using the SPS resource corresponding to QoS flow 1.

The reception of the first uplink packet at the UPF 300 on QoS flow 4 may serve as an indication that the UPF 300 may or has to switch from using QoS flow 1 to QoS flow 3 for all downlink packets it receives during the next (e.g., Qci) gate open time interval. The downlink packets the UPF receives during the next (e.g., Qci) gate open time interval are therefore all transmitted using the second PDU and/or to the gNB2 according to the step 606.

According to a fourth synchronization step, all downlink packets the gNB2 receives within time interval 2 (e.g. starting from Burst Arrival Time 2 and ending at the deadline for accumulating packets to be sent using a common MAC PDU) correspond to the downlink packets the UPF 300 receives during (e.g., Qci) gate open time interval 2 and can be transmitted using the SPS resource corresponding to QoS flow 3.

There will be no need for duplication of downlink packets at the PDCP layer of either gNB1 or gNB2 since the UPF always sends any given gNB a complete set of downlink packets to be relayed using a common MAC PDU (i.e. the full set of packets the UPF received within a given Qci gate open time interval are sent to only one gNB).

Downlink PDCP frame number continuity can be realized for inter-gNB cell change since the last downlink packet sent using QoS flow 1 in cell 1 has PDCP sequence number M and the first downlink packet sent using QoS flow 3 in cell 2 can be configured to have PDCP sequence number M+1 (e.g. during handover related signaling gNB1 can inform gNB2 of the first PDCP sequence number to be used for QoS flow 3 in cell 2).

Alternatively or in addition, when configuring SPS resources for QoS flow 3, gNB2 can simply set the PDCP sequence number to zero and begin using it for the first downlink packet it receives from the UPF on QoS flow 3 after successful handover of the UE from cell 1 to cell 2.

According to a fifth synchronization step, the UE 100 can assume that, upon reception of the first packet sent using QoS flow 3, it will have either (a) already received and forwarded the last packet the UPF sent using QoS flow 1 or (b) the last packet sent using QoS flow 1 was lost (i.e. the corresponding Packet Delay Budget (PDB) is exceeded).

Transmission of the first packet on QoS flow 3 can therefore allow the UPF 300 to release GTP-U resources used for downlink QoS flow 1 which then triggers gNB1 to release the corresponding DRB resources.

In any embodiment, the set of downlink packets (i.e., TSN data packets in the downlink) to be transmitted using a given instance of a SPS resource may be delivered according to a target PER within a corresponding PDB. This means that radio resources for QoS flow 1 in cell 1 (used for sending downlink packets received within time interval 1) can be made available for at least as long as the PDB applicable to QoS flow 1 in cell 1 (after which they can be safely released by gNB1 regardless if the MAC PDU that included that set of downlink packets was successfully delivered over the radio interface).

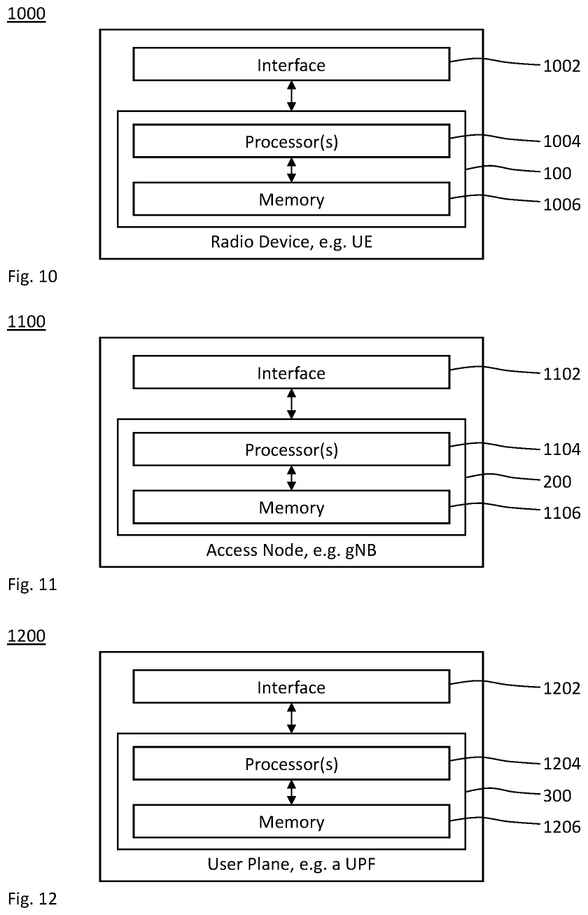

FIG. 10 shows a schematic block diagram for an embodiment of the device 100. The device 100 comprises processing circuitry, e.g., one or more processors 1004 for performing the method 300 and memory 1006 coupled to the processors 1004. For example, the memory 1006 may be encoded with instructions that implement at least one of the modules 102, 104, and 106 and/or perform steps 402, 404, and 406, respectively.

The one or more processors 1004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1006, radio device. For example, the one or more processors 1004 may execute instructions stored in the memory 1006. Such functionality may include providing various features and steps discussed herein, including any of the benefits disclosed herein. The expression “the device being operative to perform an action” may denote the device 100 being configured to perform the action.

As schematically illustrated in FIG. 10, the device 100 may be embodied by a radio device 1000, e.g., functioning as a UE. The UE 1000 comprises a radio interface 1002 coupled to the device 100 for radio communication with one or more access nodes, e.g., functioning as a eNB or gNB.

FIG. 11 shows a schematic block diagram for an embodiment of the device 200. The device 100 comprises processing circuitry, e.g., one or more processors 1104 for performing the method 300 and memory 1106 coupled to the processors 1104. For example, the memory 1106 may be encoded with instructions that implement at least one of the modules 202, 204, and 206 and/or performing the steps 502, 504, and 506, respectively.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1106, access node functionality. For example, the one or more processors 1104 may execute instructions stored in the memory 1106. Such functionality may include providing various features and steps discussed herein, including any of the benefits disclosed herein. The expression “the device being operative to perform an action” may denote the device 200 being configured to perform the action.

As schematically illustrated in FIG. 11, the device 200 may be embodied by an access node 1100, e.g., functioning as a transmitting base station or a transmitting UE. The transmitting station 1100 comprises a radio interface 1102 coupled to the device 200 for radio communication with one or more receiving stations, e.g., functioning as a receiving base station or a receiving UE.

FIG. 12 shows a schematic block diagram for an embodiment of the device 300. The device 300 comprises processing circuitry, e.g., one or more processors 1204 for performing the method 600 and memory 1206 coupled to the processors 1204. For example, the memory 1206 may be encoded with instructions that implement at least one of the modules 302, 304, and 306 and/or perform the steps 602, 604, and 606, respectively.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300, such as the memory 1206, user plane functionality. For example, the one or more processors 1204 may execute instructions stored in the memory 1206. Such functionality may include providing various features and steps discussed herein, including any of the benefits disclosed herein. The expression “the device being operative to perform an action” may denote the device 300 being configured to perform the action.

As schematically illustrated in FIG. 12, the device 300 may be embodied by a user plane 1200 of a core network, e.g., functioning as a UPF. The UPF 1200 comprises an interface 1202 coupled to the device 300 for communication with one or more access nodes, e.g., functioning as eNB or gNB.

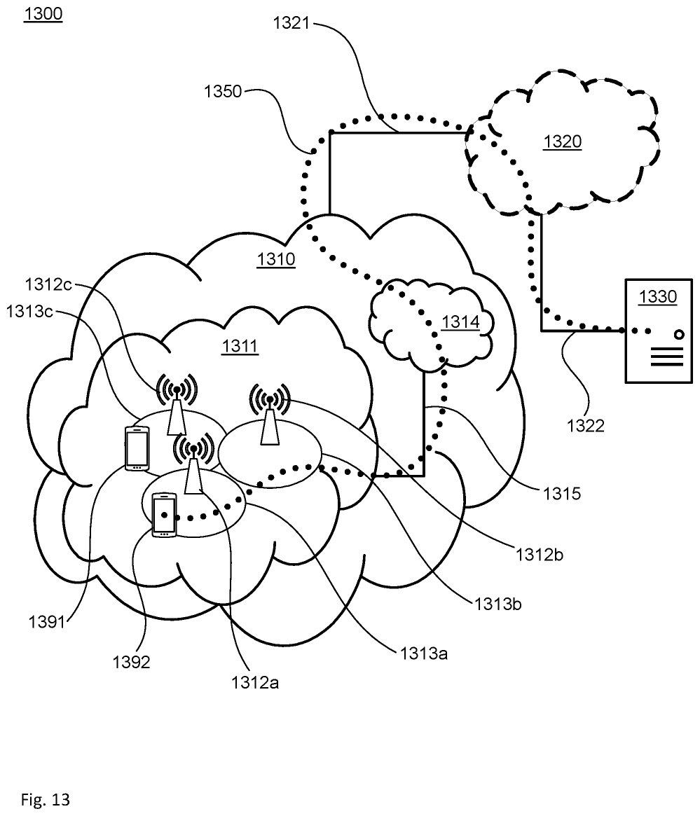

With reference to FIG. 13, in accordance with an embodiment, a communication system 1300 includes a telecommunication network 1310, such as a 3GPP-type cellular network, which comprises an access network 1311, such as a radio access network, and a core network 1314. The access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to the core network 1314 over a wired or wireless connection 1315. A first user equipment (UE) 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Any of the base stations 1312 and the UEs 1391, 1392 may embody the devices 200 and 100, respectively.

The telecommunication network 1310 is itself connected to a host computer 1330, which may be embodied in the hardware and/or software of a standalone server, a cloud-implemented server, a distributed server or as processing resources in a server farm. The host computer 1330 may be under the ownership or control of a service provider, or may be operated by the service provider or on behalf of the service provider. The connections 1321, 1322 between the telecommunication network 1310 and the host computer 1330 may extend directly from the core network 1314 to the host computer 1330 or may go via an optional intermediate network 1320. The intermediate network 1320 may be one of, or a combination of more than one of, a public, private or hosted network; the intermediate network 1320, if any, may be a backbone network or the Internet; in particular, the intermediate network 1320 may comprise two or more sub-networks (not shown).

The communication system 1300 of FIG. 13 as a whole enables connectivity between one of the connected UEs 1391, 1392 and the host computer 1330. The connectivity may be described as an over-the-top (OTT) connection 1350. The host computer 1330 and the connected UEs 1391, 1392 are configured to communicate data and/or signaling via the OTT connection 1350, using the access network 1311, the core network 1314, any intermediate network 1320 and possible further infrastructure (not shown) as intermediaries. The OTT connection 1350 may be transparent in the sense that the participating communication devices through which the OTT connection 1350 passes are unaware of routing of uplink and downlink communications. For example, a base station 1312 need not be informed about the past routing of an incoming downlink communication with data originating from a host computer 1330 to be forwarded (e.g., handed over) to a connected UE 1391. Similarly, the base station 1312 need not be aware of the future routing of an outgoing uplink communication originating from the UE 1391 towards the host computer 1330.

By virtue of at least one of the methods 400, 500, and 600, being performed by any one of the UEs 1391 or 1392 and/or any one of the base stations 1312 a access nodes 200 and/or the UPF 300, the reliability and/or latency of the OTT connection 1350 can be improved, e.g., in terms of less jitter and predictable latency. More specifically, the host computer 1330 may indicate to the radio network 702 or the radio device 100 (e.g., on an application layer or the layer 116) the QoS of the traffic.

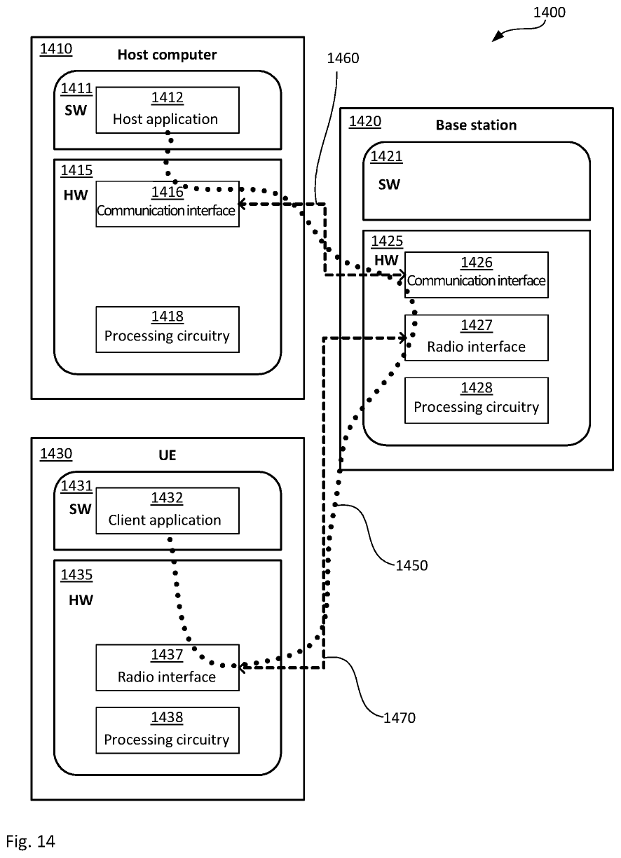

Example implementations, in accordance with an embodiment of the UE, base station and host computer discussed in the preceding paragraphs, will now be described with reference to FIG. 14. In a communication system 1400, a host computer 1410 comprises hardware 1415 including a communication interface 1416 configured to set up and maintain a wired or wireless connection with an interface of a different communication device of the communication system 1400. The host computer 1410 further comprises processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as a UE 1430 connecting via an OTT connection 1450 terminating at the UE 1430 and the host computer 1410. In providing the service to the remote user, the host application 1412 may provide user data, which is transmitted using the OTT connection 1450. The user data may depend on the location of the UE 1430. The user data may comprise auxiliary information or precision advertisements (also: ads) delivered to the UE 1430. The location may be reported by the UE 1430 to the host computer, e.g., using the OTT connection 1450, and/or by the base station 1420, e.g., using a connection 1460.

The communication system 1400 further includes a base station 1420 provided in a telecommunication system and comprising hardware 1425 enabling it to communicate with the host computer 1410 and with the UE 1430. The hardware 1425 may include a communication interface 1426 for setting up and maintaining a wired or wireless connection with an interface of a different communication device of the communication system 1400, as well as a radio interface 1427 for setting up and maintaining at least a wireless connection 1470 with a UE 1430 located in a coverage area (not shown in FIG. 14) served by the base station 1420. The communication interface 1426 may be configured to facilitate a connection 1460 to the host computer 1410. The connection 1460 may be direct, or it may pass through a core network (not shown in FIG. 14) of the telecommunication system and/or through one or more intermediate networks outside the telecommunication system. In the embodiment shown, the hardware 1425 of the base station 1420 further includes processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The communication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, base station 1420 and UE 1430 illustrated in FIG. 14 may be identical to the host computer 1330, one of the base stations 1312a, 1312b, 1312c and one of the UEs 1391, 1392 of FIG. 13, respectively. This is to say, the inner workings of these entities may be as shown in FIG. 14, and, independently, the surrounding network topology may be that of FIG. 13.

In FIG. 14, the OTT connection 1450 has been drawn abstractly to illustrate the communication between the host computer 1410 and the UE 1430 via the base station 1420, without explicit reference to any intermediary devices and the precise routing of messages via these devices. Network infrastructure may determine the routing, which it may be configured to hide from the UE 1430 or from the service provider operating the host computer 1410, or both. While the OTT connection 1450 is active, the network infrastructure may further take decisions by which it dynamically changes the routing (e.g., on the basis of load balancing consideration or reconfiguration of the network).

The wireless connection 1470 between the UE 1430 and the base station 1420 is in accordance with the teachings of the embodiments described throughout this disclosure. One or more of the various embodiments improve the performance of OTT services provided to the UE 1430 using the OTT connection 1450, in which the wireless connection 1470 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1450 between the host computer 1410 and UE 1430, in response to variations in the measurement results. The measurement procedure and/or the network functionality for reconfiguring the OTT connection 1450 may be implemented in the software 1411 of the host computer 1410 or in the software 1431 of the UE 1430, or both. In embodiments, sensors (not shown) may be deployed in or in association with communication devices through which the OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of the OTT connection 1450 may include message format, retransmission settings, preferred routing etc.; the reconfiguring need not affect the base station 1420, and it may be unknown or imperceptible to the base station 1420. Such procedures and functionalities may be known and practiced in the art. In certain embodiments, measurements may involve proprietary UE signaling facilitating the host computer's 1410 measurements of throughput, propagation times, latency and the like. The measurements may be implemented in that the software 1411, 1431 causes messages to be transmitted, in particular empty or “dummy” messages, using the OTT connection 1450 while it monitors propagation times, errors etc.

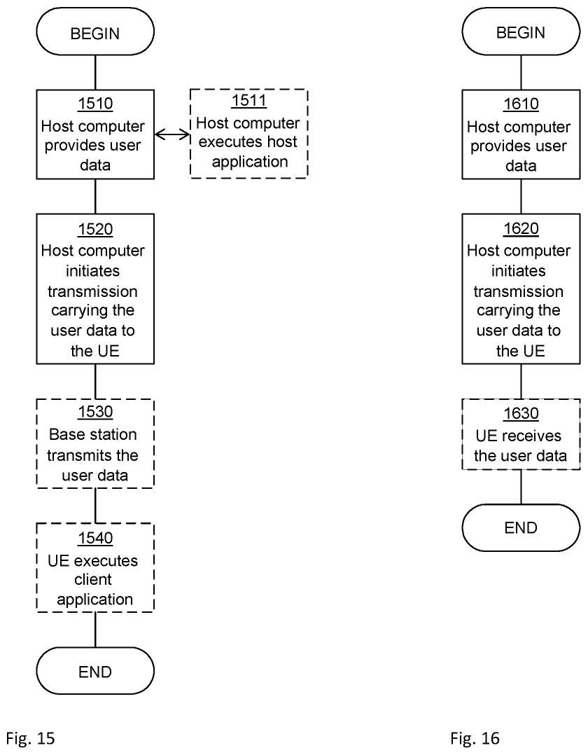

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this paragraph. In a first step 1510 of the method, the host computer provides user data. In an optional substep 1511 of the first step 1510, the host computer provides the user data by executing a host application. In a second step 1520, the host computer initiates a transmission carrying the user data to the UE. In an optional third step 1530, the base station transmits to the UE the user data which was carried in the transmission that the host computer initiated, in accordance with the teachings of the embodiments described throughout this disclosure. In an optional fourth step 1540, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this paragraph. In a first step 1610 of the method, the host computer provides user data. In an optional substep (not shown) the host computer provides the user data by executing a host application. In a second step 1620, the host computer initiates a transmission carrying the user data to the UE. The transmission may pass via the base station, in accordance with the teachings of the embodiments described throughout this disclosure. In an optional third step 1630, the UE receives the user data carried in the transmission.

Any embodiment may allocate downlink a second PDU session, e.g., QoS flow 3 and uplink QoS flow 4, in parallel with a first PDU session, e.g., QoS flow 1 and QoS flow 2, e.g. as a QoS flow centric approach, during (e.g., inter-gNB) handover. As has become apparent from above description, at least some embodiments of the technique allow for at least one of the following groups of advantages.

A first group of advantage resulting from any aspect, and/or the PDU session-centric handover or the QoS flow-centric handover, allows both downlink and uplink user plane packets to experience virtually no delay penalty as a result of an inter-gNB cell change. In other words, the PDB configured for an uplink or downlink packet can be satisfied using uplink/downlink QoS flows in either cell 1 or cell 2. This is in contrast to existing techniques for maintaining user plane continuity at cell change (handover) such as DAPS. DAPS introduces additional delays in the user plane path during cell change since it involves relaying packets from gNB1 to gNB2. The additional delay of DAPS may not be acceptable in TSN since it may result in the total packet delay introduced by the 5GS exceeding its allocated Packet Delay Budget (PDB) during at least some portion of the cell change procedure.

A second group of advantages resulting from any aspect, and/or from using the PDU session-centric or QoS flow-centric approach, for determining the switching from the first PDU session to the second PDU session (e.g., managing cell change) allows the UE to use knowledge of the (e.g., Qci) gate open interval for uplink packets to decide when to start using the second PDU session and/or uplink QoS flow 4 and/or allows the UPF to use knowledge of the (e.g., Qci) gate open interval for downlink packets to decide when to start using downlink the second PDU session and/or the QoS flow 3. For example, the UE may determine the switching (i.e., this packet routing decision) since the UE knows when configuration of resources required for QoS flow 4 is complete (e.g., at which point QoS flow 4 becomes available) and can therefore use QoS flow 2 to transmit the last set of uplink packets (that map to QoS flow 2) it began to accumulate prior to QoS flow 4 becoming available. Alternatively or in addition, the UPF may determine the switching (i.e., this packet routing decision) since the UPF knows when configuration of resources required for QoS flow 3 is complete (at which point QoS flow 3 becomes available) and can therefore use QoS flow 1 to transmit to gNB1 the last set of downlink packets (that map to QoS flow 1) received in the corresponding (e.g., Qci) gate open cycle that occurs prior to QoS flow 3 becoming available. This can eliminate the need for using the Xn-U interface to transmit downlink packets from the source gNB to target gNB which is conventionally required when using DAPS for inter-gNB cell change. The need for any PDCP packet duplications during cell change is also eliminated since each packet is sent only once using either a QoS flow in cell 1 or a QoS flow in cell 2.

A third group of advantages results from efficiently allocating and/or releasing (e.g., management) of DRB and GTP-U resources in source cell 1 and target cell 2, e.g., since redundant allocations are only required for the time period corresponding to the Packet Delay Budget (PDB). After allocation of the required DRB and GTP-U resources for the second PDU session (e.g., the QoS flows 3 and 4), the maximum amount of time during which DRB and GTP-U resources for the first PDU session (e.g., QoS flows 1 and 2) remain allocated may be determined by the PDB applicable to the first TSN data packets transmitted using the first PDU session (e.g., QoS flows 1 and 2). For example, if the last uplink MAC PDU sent in cell 1 for QoS flow 2 is not successfully delivered within the corresponding PDB then the corresponding packets are considered as lost and the corresponding DRB and GTP-U resources can be released.

However, if the last uplink MAC PDU sent in cell 1 for QoS flow 2 is successfully delivered within the corresponding PDB then the corresponding packets are considered as delivered and the DRB and GTP-U resources can be released immediately.

Considering scenarios where the PDB is expressed in some multiple of 10 ms, the period during which DRB and GTP-U resources must remain allocated for QoS flows 1 and 2 in cell 1 (i.e., in parallel with DRB and GTP-U resources for QoS flows 3 and 4 in cell 2) is short and therefore the impact on radio resource availability in cell 1 can be considered as small.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of forwarding data packets at a radio device during a handover of the radio device from a source cell to a target cell of a radio network serving as a time-sensitive networking (TSN) bridge, the method comprising:
forwarding first TSN data packets in the source cell using a first PDU session between the radio device and a user plane (UP) of a core network (CN) of the radio network;
prior to releasing the first PDU session, establishing a second PDU session between the radio device and the UP of the CN in the target cell, wherein the first PDU session uses a first active protocol stack at the radio device and the second PDU session uses a second active protocol stack at the radio device; and
forwarding second TSN data packets in the target cell using the second PDU session.

2. The method of claim 1, wherein the radio device switches from using the first PDU session to using the second PDU at a point in time that is determined by or consistent with the radio network serving as the TSN bridge and/or the point in time is determined by and/or consistent with a gate open time interval for the TSN bridge and/or a TSN assistance information, TSCAI, for the TSN bridge and/or a forwarding configuration of the TSN bridge.

3. The method of claim 1, wherein the forwarding of the first TSN data packets comprises an uplink transmission of the first TSN data packets to the UP of the CN using the first PDU session, and wherein the forwarding of the second TSN data packets comprises an uplink transmission of the second TSN data packets to the UP of the CN using the second PDU session, and wherein switching from the transmission using the first PDU session to the transmission using the second PDU session is synchronized with at least one of
the serving as the TSN bridge,
the gate open time interval for the TSN bridge, and
the TSCAI for the TSN bridge.

4. The method of claim 1, wherein the radio device is allocated a downlink radio resource for a first QoS flow in the first PDU session and an uplink radio resource for a second QoS flow in the first PDU session.

5. The method of claim 1, wherein the radio device is allocated a downlink radio resource for a third QoS flow in the second PDU session and an uplink radio resource for a fourth QoS flow in the second PDU session.

6. The method of claim 1, wherein the second PDU session is established responsive to receiving a control message in the source cell, optionally a radio resource control, RRC, message.

7. The method of claim 6, wherein the control message is indicative of at least one of the handover, the serving as a TSN bridge, a reduction of an interruption time during the handover, and separately using a first active protocol stack for the source cell and a second active protocol stack for the target cell.

8. The method of claim 1, wherein
the first TSN data packets in the first PDU session and the second TSN data packets in the second PDU session are forwarded from a device-side TSN translator (DS-TT) at the radio device for uplink transmission to the UP of the CN, and/or
the first TSN data packets in the first PDU session and the second TSN data packets in the second PDU session are forwarded (402, 406) to the DS-TT at the radio device after downlink reception from the UP of the CN.

9. The method of claim 1, wherein the forwarding (402, 406) of the first TSN data packets in the first PDU session and/or the second TSN data packets in the second PDU session comprises temporarily gating the respective TSN data packets according to the gate open time interval for the TSN bridge and/or the TSCAI for the TSN bridge and/or the forwarding configuration of the TSN bridge.

10. The method of claim 1, wherein the same gate open time interval for the TSN bridge and/or the same TSCAI for the TSN bridge and/or the same forwarding configuration of the TSN bridge is applied to both the first TSN data packets in the first PDU session and the second TSN data packets in the second PDU session.

11. The method of claim 1, wherein the forwarding of the first TSN data packets comprises transmitting the first TSN data packets in the first PDU session until the switching to the second PDU session at a point in time after completion of the second PDU session in the target cell.

12. The method of claim 1, wherein the radio device is configured to continue at last one of downlink reception and uplink transmission of the first TSN data packets in the source cell using the first PDU session while establishing the second PDU session in the target cell.

13. The method of claim 1, wherein the first active protocol stack and the second active protocol stack are simultaneously active at the radio device during the handover.

14-22. (canceled)

23. A method of forwarding data packets at an access node serving in a source cell a radio device during a handover of the radio device from the source cell to a target cell of a radio network serving as a time-sensitive networking (TSN) bridge, the method comprising:
forwarding first TSN data packets in a first PDU session between the radio device and a user plane (UP) of a core network (CN) of the radio network;
determining the handover based on a measurement report received from the radio device; and
transmitting a control message to the radio device, the control message being configured to trigger the radio device to establish a second PDU session in the target cell.

24. The method of claim 23, wherein the access node continues forwarding the first TSN data packets in a first PDU session between the radio device and the UP of the CN after the establishing of the second PDU session between the radio device and the UP of the CN in the target cell.

25. The method of claim 24, wherein the control message is indicative of at least one of the handover, the serving as a TSN bridge, a reduction of an interruption time during the handover, and separately using the first active protocol stack for the source cell and the second active protocol stack for the target cell.

26. (canceled)

27. A method of forwarding data packets at a user plane (UP) of a core network (CN) of a radio network during a handover of a radio device from a source cell to a target cell of the radio network serving as a time-sensitive networking (TSN) bridge, the method comprising:
forwarding first TSN data packets through the source cell using a first PDU session between the radio device and the UP of the CN;
prior to releasing the first PDU session, establishing a second PDU session between the radio device and the UP of the CN in the target cell; and
forwarding second TSN data packets through the target cell using the second PDU session.

28. The method of claim 27, further comprising or initiating the step of:
transferring all TSN configuration information from the first PDU session to the second PDU session, optionally wherein the TSN configuration information comprises at least one of a forwarding configuration of the TSN bridge; a gate open time interval for the TSN bridge; and a TSN assistance information, TSCAI, for the TSN bridge.

29-35. (canceled)

36. A user equipment, (UE) configured to communicate with an access node or with a radio device functioning as a gateway, the UE comprising a radio interface and processing circuitry configured to:
forward first TSN data packets in the source cell using a first PDU session between the radio device and a user plane (UP) of a core network (CN) of the radio network;
prior to releasing the first PDU session, establish a second PDU session between the radio device and the UP of the CN in the target cell, wherein the first PDU session uses a first active protocol stack at the radio device and the second PDU session uses a second active protocol stack at the radio device; and
forward second TSN data packets in the target cell using the second PDU session.

37. (canceled)

38. An access node for forwarding data packets at the access node serving in a source cell a radio device during a handover of the radio device from the source cell to a target cell of a radio network serving as a time-sensitive networking (TSN) bridge, the access node comprising memory operable to store instructions and processing circuitry operable to execute the instructions, such that the network access node is operable to:
forward first TSN data packets in a first PDU session between the radio device and a user plane (UP) of a core network (CN) of the radio network;
determine the handover based on a measurement report received from the radio device; and
transmit a control message to the radio device, the control message being configured to trigger the radio device to establish a second PDU session in the target cell.

39-54. (canceled)
